(19) United States
(12) Patent Application Publication
(10) Pub. No.: US 2016/0200625 A1
(43) Pub. Date: Jul. 14, 2016

(54) GLASS SHEET

(71) Applicant: Asahi Glass Company, Limited, Chiyoda-ku (JP)

(72) Inventors: SATOSHI MIYASAKA, TOKYO (JP); RYOSUKE KATO, TOKYO (JP); MASANOBU SHIRAI, TOKYO (JP); NOBUAKI IKAWA, TOKYO (JP); TAKENORI MIURA, TOKYO (JP); KAZUHIKO YAMANAKA, TOKYO (JP); YASUO HAYASHI, TOKYO (JP); SHIRO TANII, TOKYO (JP)

(73) Assignee: Asahi Glass Company, Limited, Chiyoda-ku (JP)

(21) Appl. No.: 15/079,253

(22) Filed: Mar. 24, 2016

Related U.S. Application Data
(63) Continuation of application No. PCT/JP2014/075007, filed on Sep. 22, 2014.

(30) Foreign Application Priority Data
Sep. 25, 2013 (JP) 2013-198468
Dec. 13, 2013 (JP) 2013-258466
Dec. 13, 2013 (JP) 2013-258467

(51) Int. Cl. C03C 3/112

(52) U.S. Cl. CPC C03C 3/112; C03C 2204/08

(57) ABSTRACT

The present invention relates to a glass sheet having a fluorine concentration at one surface larger than that at the other surface, in which the following Formula (1) is satisfied and the amount of fluorine contained in the glass is more than 0.23 mol %·μm and 21 mol %·μm or less on a depth-direction profile by SIMS. The fluorine concentration is an average fluorine concentration (mol %) by SIMS in the depth of from 1 to 24 μm.

1≦x (1)
(x is a maximum depth (μm) in which a slope at an arbitrary depth xi (μm) in the fluorine concentration profile by SIMS satisfies the following Formula (2)).

[F(xi+0.1)−F(xi)]/0.1=−0.015 (2)
(F(xi) represents a fluorine concentration (mol %) by SIMS at the depth xi (μm)).

### TECHNICAL FIELD

The present invention relates to a glass sheet.

### BACKGROUND ART

Recently, in flat panel display devices of mobile phones or personal digital assistances (PDAs), personal computers, televisions, car-mounted navigation display devices and the like, a thin sheet-shaped cover glass is arranged on the front side of displays so as to cover a wider region than the image display area thereof, for the purpose of protecting the displays and improving the beauty thereof.

Such flat panel display devices are required to be lighterweight and thinner, and therefore the cover glass to be used for display protection is also required to be thinned.

However, if the thickness of the cover glass is reduced, the strength thereof lowers and the cover glass itself may be broken owing to dropping or the like during use or carrying. Thus, there arises a problem that its primary role of protecting the display devices cannot be fulfilled.

Consequently, in already-existing cover glass, a glass produced by a float process (hereinafter sometimes referred to as float glass) is chemically strengthened to form a compressive stress layer on the surface thereof, thereby enhancing the scratch resistance of the cover glass.

It has been reported that a float glass is warped after chemical strengthening to impair flatness (Patent Documents 1 to 3). It is said that the warpage may be caused by the heterogeneity between the glass surface not in contact with a molten metal such as molten tin during float forming (hereinafter also referred to as top surface) and the glass surface in contact with the molten metal (hereinafter also referred to as bottom surface), thereby providing a difference in the degree of chemical strengthening between the two surfaces.

The warpage of the float glass becomes large with increasing the degree of chemical strengthening. Accordingly, in the case where surface compressive stress is set to be higher than before, especially 600 MPa or more, for responding to the requirement for high scratch resistance, the problem of warpage becomes more obvious.

Patent Document 1 discloses a glass strengthening method of conducting chemical strengthening after formation of an SiO₂ film on a glass surface, to thereby control the amount of the ions entering the glass during the chemically strengthening. Patent Documents 2 and 3 disclose a method of reducing the warpage after chemical strengthening by controlling the surface compression stress on the top surface side so as to fall within a specific range.

Heretofore, for reducing the problem of warpage, there have been taken a coping method of reducing the strengthening stress caused by chemical strengthening or performing chemical strengthening after removing a surface heterogeneous layer by grinding treatment, polishing treatment, or the like of at least one surface of glass.

### PRIOR ART DOCUMENTS

### Patent Documents

Patent Document 1: US-A-2011/0293928

Patent Document 2: WO 2007/004634

Patent Document 3: JP-A-S62-191449

### SUMMARY OF THE INVENTION

### Problems that the Invention is to Solve

However, in the method described in Patent Document 1 in which chemical strengthening is performed after formation of an SiO₂ film on a glass surface, the preheating conditions during the chemical strengthening are restricted and further, there is a possibility that film quality of the SiO₂ film would change depending on the conditions to give influence on the warpage. In addition, the method as described in Patent Documents 2 and 3 in which the surface compressive stress on the top surface side is controlled so as to fall within a specific range is problematic from the viewpoint of strength of the glass.

The method of performing grinding treatment, polishing treatment or the like on at least one surface of glass before chemical strengthening is problematic from the viewpoint of improving the productivity, and therefore it is preferable to omit the grinding treatment, polishing treatment or the like.

In the case where warpage may occur in a certain degree or more after chemical strengthening, the gap between the glass and a stage would be too large at the time of printing a black frame of a cover glass and therefore the glass may not be suctioned on the stage. Moreover, in the case of being used as a cover glass integrated with a touch panel, a film of ITO (Indium Tin Oxide) or the like may be formed thereon in the state of a large sheet in a later step. At that time, there may occur such transport failure that the glass would be brought into contact with an air knife in a chemical liquid processing tank or in a washing tank, or there may arise such trouble that the warpage may increase during the formation of ITO film and thus the ITO film formation condition in the substrate peripheral part may not be suitable and would peel away. Furthermore, in the case of a type where there exists a space between an LCD (Liquid Crystal Display) and the cover glass having a touch panel attached thereto, if the cover glass has warpage in a certain degree or more, there may occur luminance unevenness or Newton rings.

Accordingly, an object of the present invention is to provide a glass sheet in which warpage after chemical strengthening can be effectively suppressed and polishing treatment or the like before chemical strengthening can be omitted or simplified.

### Means for Solving the Problems

The present inventors have found that the occurrence of a difference in the degree of chemical strengthening on one surface and the other surface of a glass can be suppressed by subjecting a glass surface to fluorine treatment and thus the warpage after chemical strengthening can be reduced. Based on the findings, they have accomplished the present invention.

That is, the present invention is as follows.

1. A glass sheet having a fluorine concentration at one surface larger than a fluorine concentration at the other surface, the surfaces being opposite to each other in a thickness direction, in which the following Formula (1) is satisfied and the amount of fluorine contained in the glass is more than 0.23 mol %·μm and 21 mol %·μm or less on a depth-direction profile by secondary ion mass spectrometry (SIMS) in which a horizontal axis expresses depth and a vertical axis expresses fluorine concentration (mol %). The fluorine concentration is an average fluorine concentration (mol %) by SIMS in the depth of from 1 to 24 μm.

1≦x (1)

In Formula (1), x is a maximum depth (μm) in which a slope at an arbitrary depth xi (μm) in the fluorine concentration profile by SIMS satisfies the following Formula (2).

[F(xi+0.1)−F(xi)]/0.1=−0.015 (2)

In Formula (2), F(xi) represents a fluorine concentration (mol %) by SIMS at the depth xi (μm).

2. The glass sheet according to the above 1, in which the amount of fluorine contained in the glass is 0.7 mol %·μm or more and 9 mol %·μm or less.
3. A glass sheet having a fluorine concentration at one surface larger than a fluorine concentration at the other surface, the surfaces being opposite to each other in a thickness direction, in which the following Formula (1′) is satisfied. The fluorine concentration is an average fluorine concentration (mol %) by SIMS in a depth of from 1 to 24 μm.

10≦x (1′)

In Formula (1′), x is a maximum depth (μm) in which a slope at an arbitrary depth xi (μm) in a fluorine concentration profile by SIMS satisfies the following Formula (2).

[F(xi+0.1)−F(xi)]/0.1=−0.015 (2)

In Formula (2), F(xi) represents a fluorine concentration (mol %) by SIMS at the depth xi (μm).

4. The glass sheet according to any one of the above 1 to 3, which is a glass sheet manufactured by a float process.
5. The glass sheet according to any one of the above 1 to 4, which has a thickness of 1.5 mm or less.
6. The glass sheet according to any one of the above 1 to 5, which has a thickness of 0.8 mm or less.
7. The glass sheet according to any one of the above 1 to 6, which has a surface roughness Ra of 2.5 nm or less.
8. A glass sheet obtained by chemically strengthening the glass sheet described in any one of the above 1 to 7.
9. A flat panel display device equipped with a cover glass, in which the cover glass is the glass sheet described in the above 8.

### Advantage of the Invention

The glass sheet of the present invention is subjected to fluorine treatment on the surface thereof and thereby, it is possible to suppress the occurrence of a difference in the degree of chemical strengthening on one surface and the other surface of the glass, and the stress value by the chemical strengthening can be controlled to a desired value. Moreover, even in the case where the polishing treatment or the like before chemical strengthening is simplified or omitted, the warpage of the glass after chemical strengthening can be reduced and excellent flatness can be obtained.

### BRIEF DESCRIPTION OF THE DRAWINGS

FIG. 1 is a view schematically illustrating a double-flow type injector employable in the present invention.

FIG. 2 is a view schematically illustrating a single-flow injector employable in the present invention.

FIG. 3 is a cross-sectional view of a flat panel display, in which the float glass for chemical strengthening of the present invention is chemically strengthened and then used as a cover glass for the flat panel display.

(a) of FIG. 4 illustrates a schematic explanatory view of a method of supplying a gas containing a molecule having a fluorine atom in the structure thereof with a beam to treat a glass ribbon surface, in the manufacture of a glass sheet by a float process. (b) of FIG. 4 is an A-A cross-sectional view of (a) of FIG. 4.

(a) to (d) of FIG. 5 each illustrates a cross-sectional view of a beam in which the amount of the gas can be adjusted while dividing it into three portions in the width direction of a glass ribbon.

(a) to (c) of FIG. 6 each shows a typical fluorine concentration profile by SIMS of aluminosilicate glass subjected to fluorine treatment.

(a) to (c) of FIG. 7 each shows a typical H₂O concentration profile by SIMS of aluminosilicate glass.

FIG. 8 shows a typical IR spectrum of aluminosilicate glass.

(a) of FIG. 9 shows a typical fluorine concentration profile by SIMS of aluminosilicate glass. (b) of FIG. 9 shows a view in which depth is plotted on a horizontal axis and a slope at an arbitrary spot xᵢ represented by Formula (a) is plotted on a vertical axis. (c) of FIG. 9 shows an enlarged view of the dotted portion in (b) of FIG. 9.

FIG. 10 is a view showing a method of calculating the F amount contained in a glass from SIMS profile.

FIG. 11 is a view showing a relationship between the F amount contained in a glass of the glass sheet (soda lime glass) according to the present invention determined by SIMS and the warpage displacement amount after the glass is subjected to a chemically strengthening treatment.

FIG. 12 is a view showing a relationship between the F amount contained in a glass of the glass sheet (aluminosilicate glass) according to the present invention determined by SIMS and the warpage displacement amount after the glass is subjected to a chemically strengthening treatment.

FIG. 13 illustrates an explanatory view of mechanism of the occurrence of concave portion by HF treatment.

### MODES FOR CARRYING OUT THE INVENTION

### 1. Glass Sheet

In the present invention, the “glass sheet” includes also a molten glass formed into a sheet shape and, for example, a so-called glass ribbon in a float bath is also a glass sheet. Warpage of the glass sheet after chemical strengthening occurs due to a difference in the degree of chemical strengthening on one surface and the other surface of the glass sheet. Specifically, for example, in the case of a float glass, the warpage after chemical strengthening occurs due to the difference in the degree of chemical strengthening between a glass surface (top surface) which is not brought into contact with molten metal (usually tin) during float forming and a glass surface (bottom surface) which is brought into contact with the molten metal.

According to the glass sheet of the present invention, typically, one surface of the glass sheet is subjected to fluorine treatment, and thereby, diffusion rates of ions in one surface and the other surface of the glass sheet can be controlled and thus the degrees of chemical strengthening in the one surface and the other surface can be controlled. For this reason, in the glass sheet of the present invention, it is possible to reduce the warpage of the glass sheet after chemical strengthening without controlling strengthening stress or without conducting such a treatment as grinding or polishing before chemical strengthening treatment.

As the mechanism for achieving the reduction of the warpage after chemical strengthening by subjecting the surface of a glass sheet to a fluorine treatment, it is considered that the following phenomena take place.

(1) Relaxation is promoted by fluorine incorporated into the glass surface to lower CS (compressive stress, surface compressive stress) of the surface subjected to the fluorine treatment.
(2) Ion exchange is inhibited by the fluorine incorporated into the glass surface to lower DOL (depth of layer, depth of compressive stress) of the surface subjected to the fluorine treatment.
(3) Dealkalization of the glass is caused by the fluorine treatment.
(4) The main component in the glass surface is changed by the fluorine treatment and Si in the glass is reduced from the glass surface as SiF₄ or H₂SiF₆ and, so that the degree of the stress is changed.
(5) Dehydration from the glass surface is suppressed or water enters due to the fluorine treatment and thereby the warpage is reduced.

### 1A. Parameters Defining Appropriate Fluorine Addition Amount for Warpage Improvement

The warpage caused by chemical strengthening a glass occurs due to the difference in the degree of chemical strengthening on the top surface and the bottom surface. The difference in the degree of chemical strengthening is considerably affected by the water content in the glass. Although the warpage caused by chemical strengthening of the glass is improved through various factors by adding fluorine to the glass surface layer, as for an appropriate amount of the fluorine to be added to the glass, the following parameters are set in consideration of the difference in water content on the top surface and the bottom surface.

It is preferred that the glass sheet of the present invention is a glass sheet having a fluorine concentration at one surface larger than fluorine concentration at the other surface, the surfaces being opposite to each other in a thickness direction, in which the following Formula (A) is satisfied. The fluorine concentration can be obtained through the following procedures.

0.1≦ΔF/ΔH₂O (A)

In Formula (A), ΔF is a value obtained by subtracting the average fluorine concentration (mol %) by SIMS in the depth of from 1 to 24 μm at the surface having smaller fluorine concentration from the average fluorine concentration (mol %) by SIMS in the depth of from 1 to 24 μm at the surface having larger fluorine concentration.

The fluorine concentration is obtained by performing a measurement of a fluorine concentration profile in the glass on an SIMS apparatus and calculating the concentration from the profile through the following procedures (a1) to (a3). (a) to (c) of FIG. 6 each shows a typical fluorine concentration profile by SIMS of aluminosilicate glass subjected to fluorine treatment.

(a1) A fluorine concentration profile of standard samples each having a known concentration and a target sample to be measured is measured by SIMS ((a) of FIG. 6).
(a2) A calibration curve is prepared based on the measurement results of the standard samples and a coefficient for converting ¹⁹F/³⁰Si into fluorine concentration (mol %) is calculated ((b) of FIG. 6).
(a3) The fluorine concentration (mol %) of the target sample to be measured is determined based on the coefficient calculated in the step (a2). The average fluorine concentration (mol %) by SIMS in the depth of from 1 to 24 μm is a value obtained by integrating the fluorine concentration in the depth of from 1 to 24 μm and dividing the resulting value by 23 that is the coefficient ((c) of FIG. 6).

An absolute value of a difference between the values of the average fluorine concentration (mol %) by SIMS in the depth of from 1 to 24 μm, which values are calculated for opposing both surfaces in the thickness direction of the glass through the procedures (a1) to (a3), is taken as ΔF.

Secondary ion intensity I_{M1} of an isotope M₁ of an element M in SIMS is proportional to primary ion intensity Iₚ, sputtering rate Y of a matrix, concentration C_{M} (ratio relative to total concentration) of the element M, existence probability α₁ of the isotope M₁, secondary ionization rate β_{M} of the element M, and permeation efficiency η (including detection efficiency of a detector) of a mass spectrometer.

I_{M1}=A·Iₚ·Y·C_{M}·α₁·β_{M}·η (Formula w)

Here, A is a ratio of the detection area of a secondary ion relative to the scanning range of a primary ion beam. In general, since it is difficult to determine n of the apparatus, an absolute value of β_{M} cannot be determined. Therefore, η is deleted by using a main component element or the like in the same sample as a reference element and taking a ratio to (Formula w).

Here, in the case where the reference element is expressed as R and an isotope thereof is expressed as Rⱼ, (Formula x) is obtained.

I_{M1}/I_{Rj}=(C_{M}·α₁·β_{M})/(C_{R}·αⱼ·β_{R})=C_{M}/K (Formula x)

Here, K is a relative sensitivity factor of the element M to the element R.

K=(C_{R}·αⱼ·β_{R})/(α₁·β_{M}) (Formula y)

In this case, the concentration of the element M is determined from (Formula z).

C_{M}=K·I_{M1}/I_{Rj} (Formula z)

In the present invention, F corresponds to M₁ and Si corresponds to Rⱼ. Therefore, from (Formula x), the intensity ratio (F/Si) of the both is equal to one obtained by dividing the fluorine concentration C_{M} by K. That is, F/Si is a direct index of the fluorine concentration.

As analytical conditions of SIMS, for example, the following conditions may be mentioned. Incidentally, the analytical conditions shown in the following are examples, and are to be appropriately modified depending on a measuring apparatus, samples and the like. The depth on horizontal axis of the depth-direction profile by SIMS analysis can be determined by measuring the depth of analysis crater with a stylus type film thickness meter (e.g., Dektak 150 manufactured by Veeco Corp.).

### (Analytical Conditions)

Primary ion species: Cs⁺

Primary ion incidence angle: 60°

Primary acceleration voltage: 5 kV

As more specific analytical conditions, for example, the following conditions may be mentioned.

### (Analytical Conditions)

Measurement apparatus: a secondary ion mass spectrometry apparatus having a quadrupole mass spectrometer

Primary ion species: Cs⁺

Primary acceleration voltage: 5.0 kV

Primary ion current: 1 μA

Primary ion incident angle (angle from vertical direction of sample surface): 60°

Raster size: 200×200 μm²

Detection area: 40×40 μm²

Secondary ion polarity: minus

Use of electron gun for neutralization: yes

As the secondary ion mass spectrometry apparatus having a quadrupole mass spectrometer, for example, ADEPT 1010 manufactured by ULVAC-PHI Inc. may be mentioned.

In Formula (A), ΔH₂O is an absolute value of a value obtained by subtracting the average H₂O concentration (mol %) by SIMS in the depth of from 1 to 24 μm at the surface having larger fluorine concentration from the average H₂O concentration (mol %) by SIMS in the depth of from 1 to 24 μm at the surface having smaller fluorine concentration.

The average H₂O concentration (mol %) is obtained by performing a measurement of a fluorine concentration profile in the glass by an SIMS apparatus and calculating the concentration from the profile through the following procedures (b1) to (b3). (a) to (c) of FIG. 7 each shows a typical H₂O concentration profile by SIMS of aluminosilicate glass.

(b1) An H₂O concentration profile of standard samples each having a known concentration and a target sample to be measured is measured by SIMS ((a) of FIG. 7).
(b2) A calibration curve is prepared based on the measurement results of the standard samples and a coefficient for converting ¹H/³⁰Si into H₂O concentration (mol %) is calculated ((b) of FIG. 7).
(b3) The H₂O concentration (mol %) of the target sample to be measured is determined based on the coefficient calculated in the step (b2). The average H₂O concentration (mol %) by SIMS in the depth of from 1 to 24 μm is a value obtained by integrating the H₂O concentration in the depth of from 1 to 24 μm and dividing the resulting value by 23 ((c) of FIG. 7).

An absolute value of a difference between the values of the average H₂O concentration (mol %) by SIMS in the depth of from 1 to 24 μm, which values are calculated for opposing both surfaces in the thickness direction of the glass through the procedures (b1) to (b3), is taken as ΔH₂O.

In the step (b2), for the H₂O concentration in the standard samples, both of the top surface and the bottom surface of the target sample to be measured are polished to be processed so that there is no distribution in the H₂O concentration in the thickness direction of the glass, and therefor obtained is an IR spectrum of the glass by using an FT-IR apparatus. The H₂O concentration (mol %) is calculated from the intensity of the peak attributable to water in the glass. FIG. 8 shows a typical IR spectrum of aluminosilicate glass.

Namely, as for the calculation of H₂O concentration C_{H2O} (mol %) in the glass, it is determined according to Formula (ii) using the Lambert-Beer law represented by Formula (i), d: specific gravity of the glass (g/cm³), and Mw: average molecular weight of the glass.

A_{H2O}=ε_{H2O}×C×l (i)

ε_{H2O}: molar absorbance coefficient of H₂O in the glass (L mol⁻¹ cm⁻¹)

C: H₂O concentration in the glass (mol L⁻¹)

l: optical path length (cm)

[Math. 1]

C_{H2O}(mol %)=[(A_{H2O}/ε_{H2O}×l)/(d/Mw)]×100 (ii)

The warpage after chemical strengthening can be effectively suppressed by controlling 0.1≦ΔF/ΔH₂O. ΔF/ΔH₂O is preferably 0.1 or more, more preferably 0.38 or more, further preferably 0.4 or more, more preferably 1 or more, and particularly preferably 2 or more. In the case where ΔF/ΔH₂O is less than 0.1, a significant difference is not observed in the displacement of the warpage and thus the case is unsuitable. In addition, it is practically preferable that ΔF/ΔH₂O is 15 or less.

### 1B. Fluorine Amount Contained in Glass

The glass sheet of the present invention is preferably a glass sheet having an amount of fluorine contained in the glass being more than 0.23 mol %·μm and 21 mol %·μm or less on a depth-direction profile by secondary ion mass spectrometry (SIMS) in which the horizontal axis expresses depth as the glass surface being zero and the vertical axis expresses fluorine concentration (mol %).

The amount of fluorine contained in the glass can be determined, as shown in FIG. 10, by integration (mol %·μm) on the depth-direction profile by SIMS in which the horizontal axis expresses depth (μm) as the glass surface being zero and the vertical axis expresses fluorine concentration (mol %). The method for calculating the fluorine concentration in SIMS is as described above.

The amount of fluorine contained in a glass is accurately an amount of fluorine atoms contained in the whole glass sheet but, since it is considered that there is a limit in a depth to which fluorine can penetrate into the glass by fluorine treatment, actually, the amount can be regarded to be the same as the integrated value when the depth-direction profile is measured in a depth of from 0 to 30 μm from the glass surface.

It is considered that the amount (mol %·μm) of fluorine contained in a glass is in a linearly proportional relationship with the warpage displacement amount (μm) after the glass is chemically strengthened (FIG. 11 and FIG. 12). Here, the warpage displacement amount is determined according to the following formula.

Warpage Displacement Amount=ΔX−ΔY

ΔX: warpage change amount of untreated glass sheet caused by chemical strengthening

ΔY: warpage change amount of treated glass sheet caused by chemical strengthening

Here, the warpage change amount is a value obtained by subtracting the warpage amount of a glass sheet before chemical strengthening from the warpage amount of the glass sheet after the chemical strengthening. The warpage change amount is as follows: ΔX>0. As for ΔY, ΔY>0 in the case where the warpage occurs in the same direction as that in the case of ΔX and ΔY<0 in the case where the warpage occurs in the direction reverse to that in the case of AX.

In the case where the amount of fluorine contained in a glass falls within the above range, the warpage due to chemical strengthening can be improved regardless of the type of the glass. Especially, glass produced by a float process is preferred because an effect of improvement in warpage is much observed. The amount of fluorine contained in a glass is preferably more than 0.23 mol %·μm and is more preferably 0.7 mol %·μm or more. In the case where the amount of fluorine contained in a glass is 0.23 mol %·μm or less, no significant difference in displacement of warpage is observed. In addition, practically, the amount of fluorine contained in a glass is preferably 21 mol %·μm or less, and more preferably 9 mol %·μm or less.

Furthermore, in the case where the glass is aluminosilicate glass, the amount is preferably more than 0.23 mol %·μm and 7 mol %·μm or less and further preferably more than 0.23 mol %·μm and 6 mol %·μm or less.

Here, details of the glass composition will be described later.

Even with respect to the glass sheet after chemical strengthening, the glass sheet of the present invention has an amount of fluorine contained in the glass of preferably more than 0.23 mol %·μm and 21 mol %·μm or less on the depth-direction profile by secondary ion mass spectrometry (SIMS) in which the horizontal axis expresses depth (μm) and the vertical axis expresses fluorine concentration (mol %).

The glass sheet of the present invention may contain fluorine in both surfaces or may contain fluorine only in one surface. Especially, the latter is preferable from the viewpoint of warpage improvement.

In the present specification, one surface and the other surface of a glass sheet mean one surface and the other surface which are opposite to each other in the sheet thickness direction. In addition, the both surfaces of a glass sheet mean both surfaces which are opposite to each other in the sheet thickness direction.

### 1C. Parameter Defining Fluorine Penetration Depth for Warpage Improvement

The warpage after chemical strengthening is improved by adding fluorine to the glass surface layer. In consideration of fluorine penetration depth, the following parameters are set.

The glass sheet of the present invention is a glass sheet having a fluorine concentration at one surface larger than fluorine concentration at the other surface, the surfaces being opposite to each other in a thickness direction, in which the following Formula (1) is satisfied.

1≦x (1)

In Formula (1), x is a maximum depth (μm) in which a slope at an arbitrary depth xᵢ (μm) in the fluorine concentration profile by SIMS satisfies the following Formula (2).

[F(xᵢ+0.1)−F(xᵢ)]/0.1=−0.015 (2)

In Formula (2), F(xᵢ) represents fluorine concentration (mol %) by SIMS at a depth xᵢ (μm).

(a) of FIG. 9 shows a typical fluorine concentration profile by SIMS of aluminosilicate glass subjected to fluorine treatment. (b) of FIG. 9 is a graph in which depth is plotted on a horizontal axis and a slope at an arbitrary spot xᵢ represented by the following Formula (a) is plotted on a vertical axis. In the following Formula (a), F(x) represents fluorine concentration (mol %) at a point x.

[F(xᵢ+Δx)−F(xᵢ)]/Δx (a)

In the case where Δx is 0.1, the maximum depth x (μm) at which the slope represented by Formula (a) is −0.015 is 1 or more, preferably 2 or more, more preferably 2.8 or more, further preferably 3 or more, further more preferably 5 or more, particularly preferably 10 or more, and most preferably 20 or more. In the case where x is less than 1, no significant difference is observed in the displacement of warpage.

In the second embodiment of the present invention, x is 10 or more. In the case of controlling x to 10 or more, there are obtained effects that (1) the penetration depth of fluorine into a glass is made deep and the fluorine concentration at the outermost surface in the glass is reduced, so that DOL dependency of the warpage of the glass caused by chemical strengthening can be suppressed, (2) even in the case where a glass is subjected to polishing or etching treatment before chemical strengthening, the reducing effect of the warpage of the glass after chemical strengthening, which is obtained by the fluorine treatment, can be sufficiently secured by making the penetration depth of fluorine into the glass deep, (3) fluorine concentration at the glass outermost surface is prevented from being increased by the fluorine treatment and it becomes possible to make ACS (a difference between a CS value of opposing one surface in the thickness direction and a CS value of the other surface) close to 0, so that glass in which the warpage caused by chemical strengthening is reduced and which is also excellent in strength can be obtained.

Since the fluorine penetrating into a glass exceeding DOL does not contribute the reduction of the warpage, a realistic upper limit of x is equal to DOL. Specifically, x is preferably 40 or less. In the case of controlling x to 40 or less, the warpage caused by chemical strengthening can be efficiently reduced.

(c) of FIG. 9 is an enlarged view of the dotted portion of the graph in (b) of FIG. 9. For example, in (c) of FIG. 9, in the case where Δx is 0.1, the maximum depth x (μm) at which the slope represented by Formula (a) is −0.015 is 6.5.

### 1D. Parameter Defining Appropriate Fluorine Concentration Distribution in Thickness Direction for Warpage Improvement

The warpage caused by chemical strengthening of glass is attributable to the difference in the degree of chemical strengthening on the top surface and the bottom surface. The warpage caused by chemical strengthening of glass is improved through various factors by adding fluorine to the glass surface layer. As for concentration distribution of the fluorine to be added to the glass, the following parameters are set in consideration of fluorine penetration depth on the top surface.

The glass sheet of the present invention is preferably a glass sheet having a fluorine concentration at one surface larger than fluorine concentration at the other surface, the surfaces being opposite to each other in a thickness direction, in which the glass sheet has a surface layer fluorine ratio represented by the following Formula (I) of 0.1 or more and less than 0.5 and F₀₋₃ represented by the following Formula (II) of more than 0.02.

Surface layer fluorine ratio=F₀₋₃/F₀₋₃₀ (I)

In Formula (I), F₀₋₃ is an amount of fluorine in the glass surface (depth from the glass surface: 0 to 3 μm) and is determined according to the following Formula (II).

F₀₋₃=[Average fluorine concentration (mol %) by SIMS in the depth of from 0 to 3 μm on the surface having larger fluorine concentration]×3 (II)

In Formula (I), F₀₋₃₀ is an amount of fluorine incorporated into the glass by fluorine treatment and is determined according to the following Formula (III).

F₀₋₃₀=[Average fluorine concentration (mol %) by SIMS in the depth of from 0 to 30 μm on the surface having larger fluorine concentration]×30 (III)

The calculation method of the average fluorine concentration (mol %) by SIMS is as mentioned before.

By controlling the surface layer fluorine ratio to 0.1 or more, the warpage of the glass after chemical strengthening can be effectively suppressed. The surface layer fluorine ratio is preferably 0.1 or more and more preferably 0.15 or more.

The surface layer fluorine ratio is preferably less than 0.5, more preferably 0.4 or less, and further preferably 0.3 or less. In the case where the surface layer fluorine ratio is 0.4 or less, particularly 0.3 or less, the effects of the following (1) to (3) become remarkable and thus the case is more preferable.

(1) The warpage caused by chemical strengthening of glass is generated by a difference in compressive stress between both surfaces of the glass. In general, a glass sheet made by a float process has different compositional distribution in the depth direction of the front and rear surfaces thereof. Therefore, the degree of the compressive stress caused by chemical strengthening in the depth direction also differs in the front and rear surfaces of the glass and, as a result, warpage is generated on the glass. The warpage depends on a thickness of a compressive stress layer (hereinafter designated as DOL). On the other hand, as a result of investigation of the present inventors, it has been found that fluorine in glass has an effect of relaxing the compressive stress generated by chemical strengthening. Accordingly, by introducing fluorine into a glass surface, the difference in the compressive stress of the glass front and rear surfaces mentioned above can be reduced to decrease the warpage. At this time, of the compressive stress generated to the depth of DOL, stress relaxation occurs in the region to the depth of fluorine penetration. Therefore, in the case where the depth of fluorine penetration is deep, the variation of the ratio of the depth of fluorine penetration to the depth of the compressive stress decreases when DOL varies, so that the variation of stress relaxation decreases. As a result, the variation of the warpage improvement amount also decreases. For the above reasons, in the case where the surface layer fluorine ratio is controlled to 0.4 or less or particularly 0.3 or less by fluorine treatment, the penetration depth of fluorine into the glass can be made deep and the fluorine concentration on the outermost surface in the glass can be reduced, thereby suppressing the DOL dependency of warpage of the glass caused by chemical strengthening.
(2) In the case where a glass is subjected to polishing or etching treatment after the glass is subjected to fluorine treatment, the fluorine in the glass surface decreases and the effect of reducing the warpage after chemical strengthening, which is obtained by the fluorine treatment, decreases. By controlling the surface layer fluorine ratio to 0.4 or less or particularly 0.3 or less to deepen the penetration depth of fluorine into the glass by fluorine treatment, even in the case where the glass is subjected to a polishing or etching treatment before chemical strengthening, the effect of reducing the warpage of the glass after chemical strengthening by fluorine treatment can be sufficiently secured.
(3) If the fluorine concentration on the outermost surface is increased by fluorine treatment of one surface of the glass, the stress is relaxed only on the one surface by fluorine and there is a problem that CS is difficult to generate. In the case where the surface layer fluorine ratio is controlled to 0.4 or less or particularly 0.3 or less by fluorine treatment, an increase in the fluorine concentration of the outermost surface can be prevented and it becomes possible to make ACS (a difference between the value of CS of opposing one surface in the thickness direction and the value of CS of the other surface) be close to 0, so that glass in which the warpage caused by chemical strengthening is reduced and which is also excellent in strength can be obtained.

In order to control the surface layer fluorine ratio to 0.4 or less, particularly 0.3 or less, there may be mentioned a method of controlling the surface temperature of the glass sheet to preferably (Tg+230° C.) or higher, more preferably (Tg+300° C.) or higher in the case where the glass transition temperature of the glass sheet is referred to as Tg, at the time when a gas or liquid containing a molecule having a fluorine atom in the structure thereof (hereinafter also referred to as fluorine-containing fluid) is supplied to the surface of the glass sheet during conveying to treat the surface, as mentioned later.

Besides, as methods for controlling the surface layer fluorine ratio to 0.4 or less, there may be mentioned a method of lengthening the time for the treatment with fluorine, a method of volatilizing fluorine on the surface by performing heating treatment again after fluorine treatment of the glass, and the like.

### 2. Method of Manufacturing Glass Sheet

A method of forming a glass sheet having a sheet shape from molten glass in the present invention is not particularly limited, and glass having any composition may be used insofar as the glass has a composition capable of being strengthened by chemical strengthening treatment. For example, various raw materials are compounded in appropriate amounts, heated and molten, and subsequently homogenized by defoaming, stirring or the like, and the resulting one is formed into a sheet shape by a well-known float process, a down-draw process (e.g., a fusion process, etc.), a press process, or the like, and after annealing, the sheet is cut to a desired size, followed by subjecting to polishing. Of these manufacturing methods, in particular, glass manufactured by a float process is preferable since warpage improvement after chemical strengthening, which is the effect of the present invention, is easily exhibited.

As the glass sheet which is used in the present invention, specifically, for example, a glass sheet formed of a soda-lime silicate glass, an aluminosilicate glass, a borate glass, a lithium aluminosilicate glass, or a borosilicate glass is typically mentioned.

Of these, glass having a composition containing Al is preferable. If alkali coexists, Al is tetracoordinated, and similarly to Si, participates in forming a network that becomes a skeleton of glass. If tetracoordinated Al increases, the movement of alkali ions is facilitated, and ion exchange easily proceeds during chemical strengthening treatment.

The thickness of the glass sheet is not particularly limited, and for example, there may be mentioned 2 mm, 0.8 mm, 0.73 mm, 0.7 mm, 0.56 mm, and 0.4 mm. In order to effectively perform chemical strengthening treatment to be described below, the thickness is usually preferably 5 mm or less, more preferably 3 mm or less, further preferably 1.5 mm or less, and particularly preferably 0.8 mm or less.

Usually, the warpage amount of a glass sheet having a thickness of 0.7 mm after chemical strengthening is required to be 40 μm or less. In the case of a 90 mm square glass sheet having CS of 750 MPa and DOL of 40 μm, the warpage amount after chemical strengthening is about 130 μm. On the other hand, since the warpage amount of a glass sheet after chemical strengthening is inversely proportional to the square of sheet thickness, the warpage amount in a glass sheet having a thickness of 2.0 mm becomes about 16 μm, and warpage will not substantially become a problem. Accordingly, there is a possibility that the problem of warpage after chemical strengthening is likely to occur in a glass sheet having a thickness of less than 2 mm, and typically 1.5 mm or less.

As the composition of the glass sheet of the present invention, there may be mentioned glass containing, as a composition in terms of mol %, from 50 to 80% of SiO₂, from 0.1 to 25% of Al₂O₃, from 3 to 30% of Li₂O+Na₂O+K₂O, from 0 to 25% of MgO, from 0 to 25% of CaO, and from 0 to 5% of ZrO₂, but is not particularly limited. More specifically, the following glass compositions are mentioned. For example, the description of “containing from 0 to 25% of MgO” means that MgO is not essential and may be contained up to 25%. The glass (i) is included in soda lime silicate glass and the glass (ii) or (iii) is included in aliminosilicate glass.

(i) Glass containing, as a composition in terms of mol %, from 63 to 73% of SiO₂, from 0.1 to 5.2% of Al₂O₃, from 10 to 16% of Na₂O, from 0 to 1.5% of K₂O, from 5 to 13% of MgO, and from 4 to 10% of CaO.
(ii) Glass containing, as a composition in terms of mol %, from 50 to 74% of SiO₂, from 1 to 10% of Al₂O₃, from 6 to 14% of Na₂O, from 3 to 11% of K₂O, from 2 to 15% of MgO, from 0 to 6% of CaO, and from 0 to 5% of ZrO₂, in which a total content of SiO₂ and Al₂O₃ is 75% or less, a total content of Na₂O and K₂O is from 12 to 25%, and a total content of MgO and CaO is from 7 to 15%.
(iii) Glass containing, as a composition in terms of mol %, from 68 to 80% of SiO₂, from 4 to 10% of Al₂O₃, from 5 to 15% of Na₂O, from 0 to 1% of K₂O, from 4 to 15% of MgO, and from 0 to 1% of ZrO₂,
(iv) Glass containing, as a composition in terms of mol %, from 67 to 75% of SiO₂, from 0 to 4% of Al₂O₃, from 7 to 15% of Na₂O, from 1 to 9% of K₂O, from 6 to 14% of MgO, and from 0 to 1.5% of ZrO₂, in which a total content of SiO₂ and Al₂O₃ is from 71 to 75%, a total content of Na₂O and K₂O is from 12 to 20%, and in the case where CaO is contained, the content thereof is less than 1%.

In a method of manufacturing the glass sheet of the present invention, at least one surface of the glass sheet or glass ribbon is subjected to surface treatment by bringing the surface into contact with a gas or liquid containing a molecule having a fluorine atom in the structure thereof (hereinafter also referred to as fluorine-containing fluid).

In the case where at least one surface of the glass ribbon is subjected to the surface treatment by bringing the surface into contact with the fluorine-containing fluid, the surface temperature of the glass ribbon is preferably 600° C. or higher and more preferably higher than 650° C. By controlling the temperature to higher than 650° C., the spraying treatment with the fluorine-containing fluid can be easily performed with a sufficient total fluorine contact amount for the obtained glass to reduce the warpage amount of the glass after chemical strengthening. Hereinafter, the term “glass sheet” may be used as a generic term indicating the glass sheet and the glass ribbon,

Examples of the fluorine-containing fluid include hydrogen fluoride (HF), freon (e.g., chlorofluorocarbon, fluorocarbon, hydrochlorofluorocarbon, hydrofluorocarbon, and halon), hydrofluoric acid, fluorine simple substance, trifluoroacetic acid, carbon tetrafluoride, silicon tetrafluoride, phosphorus pentafluoride, phosphorus trifluoride, boron trifluoride, nitrogen trifluoride, chlorine trifluoride, and the like but the fluid is not limited to these gases and liquids.

Of these, hydrogen fluoride, freon, or hydrofluoric acid is preferred from the viewpoint of high reactivity with the glass sheet surface. Of these gases, two or more kinds thereof may be used as a mixture. Furthermore, in the case of spraying the fluorine-containing fluid onto the glass ribbon at the time of manufacturing the glass by a float process, it is preferable that fluorine simple substance is not used since oxidation power thereof is too strong in a float bath.

In the case where a liquid is used, for example, the liquid may be supplied to the glass sheet surface by spray coating as the liquid form or the liquid may be vaporized and then supplied to the glass sheet surface. The liquid may be diluted with other liquid or gas as necessary.

The fluorine-containing fluid may contain a liquid or gas other than the liquid or gas described above, which is preferably a liquid or gas which does not react, at ordinary temperature, with the molecule having a fluorine atom.

Examples of such the liquid or gas include N₂, air, H₂, O₂, Ne, Xe, CO₂, Ar, He, Kr, and the like, and the liquid or gas is not limited thereto. Of these gases, two or more kinds thereof may be used as a mixture.

As a carrier gas of the fluorine-containing fluid, an inert gas such as N₂ or argon, is preferably used. The fluorine-containing fluid may further contain SO₂. SO₂ is used at the time of successively producing a glass sheet by a float process or the like, and prevents the occurrence of a flaw in the glass caused by a contact of a conveying roller with the glass sheet in an annealing zone. Furthermore, a gas which is decomposed at a high temperature may be included.

Furthermore, the fluorine-containing fluid may contain water vapor or water. Water vapor may be taken out by bubbling heated water with an inert gas such as nitrogen, helium, argon or carbon dioxide. In the case where a large amount of water vapor is required, it is also possible to adopt a method in which water is supplied to a vaporizer and is directly vaporized. In the following explanation, the case where HF gas is used as the fluorine-containing fluid is described as an example.

By spraying the fluorine-containing fluid to a glass or glass ribbon, fluorine is allowed to penetrate from the glass surface and thus a glass containing fluorine can be obtained.

It is necessary to adjust conditions for spraying the fluorine-containing fluid so that fluorine contained in the resulting glass is more than 0.23 mol %·μm and 21 mol %·μm or less.

For example, in the case where fluorine is allowed to penetrate into a glass ribbon by spraying the fluorine-containing fluid in a float process, fluorine atom concentration in the fluorine-containing fluid is preferably from 0.1% by volume to 15% by volume from the viewpoint of reduction of load on the facilities and is more preferably from 0.1% by volume to 10% by volume. Furthermore, the surface temperature of the glass ribbon is preferably 600° C. or higher from the viewpoint of the penetration of fluorine up to a deeper region of the glass.

The surface temperature of the glass ribbon is preferably from (Tg+50° C.) to (Tg+460° C.), more preferably from (Tg+150° C.) to (Tg+460° C.), and further preferably from (Tg+230° C.) to (Tg+460° C.), where the glass transition temperature of the glass sheet is indicated as Tg.

In the case where the fluorine-containing fluid is sprayed onto a glass ribbon, fluorine is allowed to penetrate into the glass by spraying the fluorine-containing fluid but, during the glass ribbon is annealed to manufacture a float glass sheet, a part of the penetrating fluorine may escape from the inside of the glass.

However, since the escaping amount of fluorine is minute in the purpose of the present invention, there is no technical necessity to discriminate the fluorine atom concentration in the glass ribbon from the fluorine atom concentration in the float glass after the forming step is performed.

As a specific example of the method of forming the glass sheet having a sheet shape from molten glass in the present invention, a float process will be described in detail. In the float process, a glass sheet is manufactured by using a glass manufacturing apparatus including a melting furnace in which raw materials of the glass are melted, a float bath in which the molten glass is floated on a molten metal (tin, etc.) to form a glass ribbon, and an annealing furnace in which the glass ribbon is annealed.

At the time when glass is formed on a molten metal (tin) bath, the fluorine-containing fluid may be supplied to the glass sheet being conveyed on the molten metal bath from the side (top surface) not in contact with the metal surface, thereby treating the glass sheet surface. In the annealing zone subsequent to the molten metal (tin) bath, the glass sheet is conveyed by a roller.

Here, the annealing zone includes not only the inside of the annealing furnace but also a portion where the glass sheet is conveyed from the molten metal (tin) bath into the annealing furnace in the float bath. In the annealing zone, the gas may be supplied from the side not in contact with the molten metal (tin).

(a) of FIG. 4 illustrates a schematic explanatory view of a method of supplying a fluorine-containing fluid to treat a glass surface, in the manufacture of a glass sheet by a float process.

In the float bath in which molten glass is floated on a molten metal (tin, etc.) to form a glass ribbon 101, the fluorine-containing fluid is sprayed onto the glass ribbon 101 by a beam 102 inserted into the float bath. As illustrated in (a) of FIG. 4, it is preferable that the fluorine-containing fluid is sprayed onto the glass ribbon 101 from the side which the glass ribbon 101 is not in contact with the molten metal surface. An arrow Ya represents a direction in which the glass ribbon 101 flows in the float bath.

At the position where the fluorine-containing fluid is sprayed onto the glass ribbon 101 by the beam 102, the temperature of the glass ribbon 101 is preferably from (Tg+50°) C. to (Tg+460°) C., more preferably from (Tg+150°) C. to (Tg+460°) C., and still more preferably from (Tg+230°) C. to (Tg+460°) C., in the case where a glass transition point thereof is 550° C. or higher. Preferable temperature of the glass ribbon also varies depending on the kind of the fluid to be sprayed but, in principle, the amount of fluorine in the resulting glass can be increased by spraying the fluid having a higher concentration and/or a larger amount of the fluid at higher temperature.

The position of the beam 102 may be on the upstream side or the downstream side of a radiation gate 103. It is preferable that the amount of the fluorine-containing fluid to be sprayed onto the glass ribbon 101 is from 1×10⁻⁶ to 5×10⁻³ mol/1 cm² of the glass ribbon in the case of HF.

(b) of FIG. 4 illustrates an A-A cross-sectional view of (a) of FIG. 4. The fluorine-containing fluid sprayed onto the glass ribbon 101 from the direction of Y1 by the beam 102 flows in from “IN” and flows out from the direction of “OUT”. That is, the fluid moves in the direction of arrows Y4 and Y5 and is exposed to the glass ribbon 101. Furthermore, the fluorine-containing fluid which moves in the direction of the arrow Y4 flows out from the direction of an arrow Y2, and the fluorine-containing fluid which moves in the direction of the arrow Y5 flows out from the direction of an arrow Y3.

The warpage amount of the glass sheet after chemical strengthening may vary depending on the position of the glass ribbon 101 in the width direction, and in such a case, it is preferable to adjust the amount of the fluorine-containing fluid. That is, it is preferable that the amount of the fluorine-containing fluid to be sprayed is increased at a position where the warpage amount is large, and the amount of the fluorine-containing fluid to be sprayed is decreased at a position where the warpage amount is small.

In the case where the warpage amount of the glass sheet after chemical strengthening varies depending on the position of the glass ribbon 101, the structure of the beam 102 may be made such that the amount of the fluorine-containing fluid can be adjusted in the width direction of the glass ribbon 101, and thereby, the warpage amount may be controlled in the width direction of the glass ribbon 101.

As a specific example thereof, (a) of FIG. 5 illustrates a cross-sectional view of the beam 102 in which the amount of the fluorine-containing fluid is adjusted while dividing it into three portions I to III in the width direction 110 of the glass ribbon 101. Gas systems 111 to 113 are divided by partition walls 114 and 115, and the fluorine-containing fluid is allowed to flow out from respective gas blowing holes 116 and is sprayed onto the glass.

Arrows in (a) of FIG. 5 represent the flows of the fluorine-containing fluid. Arrows in (b) of FIG. 5 represent the flows of the fluorine-containing fluid in the gas system 111. Arrows in (c) FIG. 5 represent the flows of the fluorine-containing fluid in the gas system 112. Arrows in (d) of FIG. 5 represent the flows of the fluorine-containing fluid in the gas system 113.

As a method of supplying the fluorine-containing fluid to the glass surface of a glass sheet, for example, a method of using an injector, a method of using an introduction tube, and the like are mentioned.

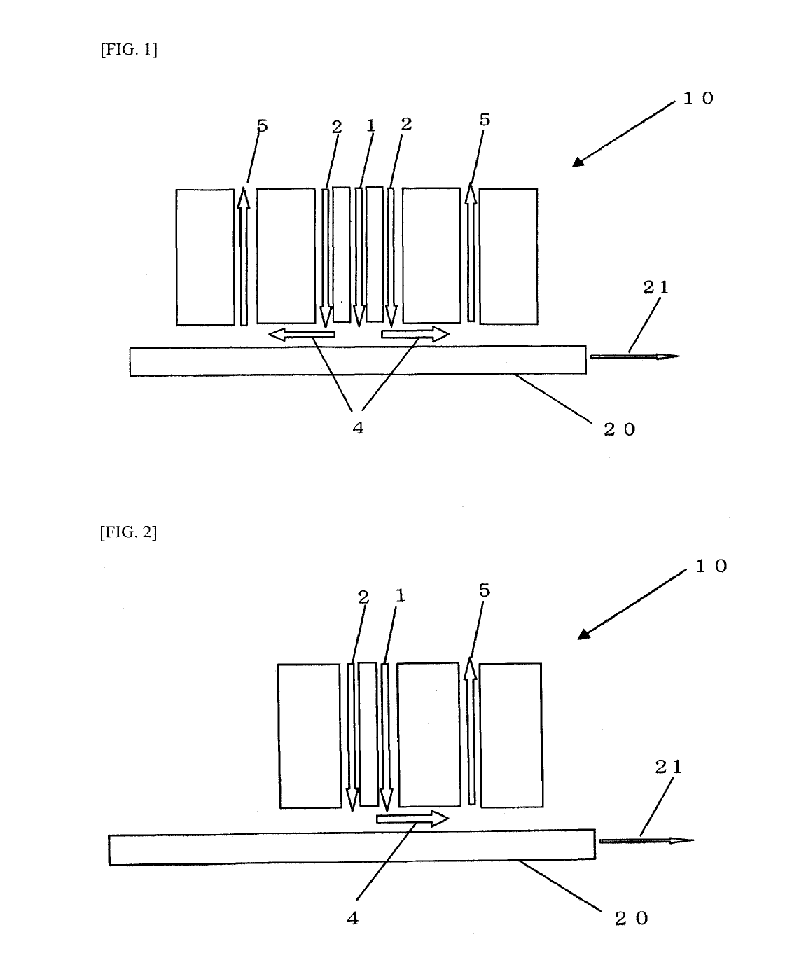

FIG. 1 and FIG. 2 illustrate schematic views of injectors for use in the surface treatment of a glass sheet, which are usable in the present invention. FIG. 1 is a view schematically illustrating a double-flow type injector usable in the present invention. FIG. 2 is a view schematically illustrating a single-flow type injector usable in the present invention.

The fluorine-containing fluid is injected toward a glass sheet 20 from a center slit 1 and an outer slit 2, flows through a channel 4 on the glass sheet 20, and is discharged from a discharge slit 5. The symbol 21 in FIG. 1 and FIG. 2 is a direction in which the glass sheet 20 flows and the direction is parallel to the channel 4.

In the case where the fluorine-containing fluid to be supplied from the injector is a gas, it is preferable that the distance between a gas injection port of the injector and a glass sheet is 50 mm or less.

By controlling the distance to 50 mm or less, it is possible to suppress the diffusion of the gas into the air and to allow a sufficient amount of the gas to reach the glass sheet with respect to a desired amount of the gas. Conversely, in the case where the distance from a glass sheet is too short, at the time when the treatment of a glass sheet to be produced by a float process is performed on-line, there is a concern that the glass sheet and the injector come into contact with each other due to fluctuation of the glass ribbon.

In the case where the fluorine-containing fluid to be supplied from the injector is a liquid, the distance between the liquid injection port of the injector and a glass sheet is not particularly limited, and an arrangement may be made such that the glass sheet can be treated uniformly.

Any type of injector, such as a double-flow type or a single-flow type, may be used, and two or more injectors may be arranged in series in the flow direction of a glass sheet to treat the glass sheet surface. As illustrated in FIG. 1, the double-flow type injector is an injector in which the flow of gas from injection to discharge is split equally into a forward direction and a backward direction with respect to the moving direction of a glass sheet.

The double-flow type injector is common and is also known as one to be used for manufacturing low reflection glass. For example, the injector may be used such that a mixed gas of 1.12 SLM (liter per minute in terms of a gas in a standard state) of HF gas and 9 SLM of nitrogen (N₂) gas is heated to 150° C. and sprayed at a flow rate of 64 cm/s from the center slit 1 and 45.5 SLM of N₂ gas is sprayed from the outer slit 2 onto soda lime silicate glass re-heated to 600° C., which is manufactured by Asahi Glass Co., Ltd (glass transition point: 560° C.) and has a thickness of 1.8 mm. Surface roughness (arithmetic average roughness) Ra of the glass surface onto which HF gas has been sprayed in such a manner is 30.6 nm and the value of x mentioned above is 2.5 μm.

As illustrated in FIG. 2, the single-flow type injector is an injector in which the flow of the gas from injection to discharge is fixed to either a forward direction or a backward direction with respect to the moving direction of a glass sheet. In the case of using the single-flow type injector, it is preferable that the flow of the gas above a glass sheet and the moving direction of the glass sheet are identical in view of gas flow stability.

Also, it is preferable that a supply port of the fluorine-containing fluid is present on the same side of the surface of the glass sheet with a discharge port of unreacted fluorine-containing fluid and a gas which is formed by a reaction with the glass sheet or a gas which is formed by a reaction of two or more kinds of gases in the fluorine-containing fluid.

At the time when the fluorine-containing fluid is supplied to the surface of a glass sheet being conveyed to perform surface treatment, for example, in the case where the glass sheet is flowing on a conveyor, the fluorine-containing fluid may be supplied from the side not in contact with the conveyor. The fluid may be supplied from the side in contact with the conveyor, by using a mesh material such as a mesh belt, with which a part of the glass sheet is not covered, as a conveyor belt.

By arranging two or more conveyors in series and disposing an injector between the adjacent conveyors, the gas may be supplied from the side in contact with the conveyor to treat the glass sheet surface. In the case where the glass sheet is flowing on a roller, the gas may be supplied from the side not in contact with the roller or may be supplied from a space between adjacent rollers on the side in contact with the roller.

The same kind or different kinds of gas(es) may be supplied from both sides of a glass sheet. For example, the gas may be supplied from both of the side not in contact with the roller and the side in contact with the roller to perform surface treatment of a glass sheet. For example, in the case where the gas is supplied from both sides in the annealing zone, injectors may be arranged so as to face each other across a glass sheet with respect to the glass being successively conveyed, and the gas may be supplied from both of the side not in contact with the roller and the side in contact with the roller.

The injector arranged on the side in contact with the roller may be arranged at different positions in the flow direction of a glass sheet from the injector arranged on the side not in contact with the roller. In the case of arranging the injectors at different positions, any of the injector may be arranged on the upstream side or the downstream side with respect to the flow direction of a glass sheet.

It is widely known that a glass sheet with a functional film is manufactured on-line in combination of a glass manufacturing technique by a float process and a CVD technique. In this case, it is known that, with regard to a transparent conductive film and its base film, a gas is supplied from the surface not in contact with tin or from the surface not in contact with the roller to form a film on a glass sheet.

For example, in the manufacture of a functional film-attached glass sheet by on-line CVD, an injector may be arranged on the surface in contact with the roller, and the fluorine-containing fluid may be supplied from the injector to the glass sheet to treat the glass sheet surface.

The pressure of the glass sheet surface when supplying the fluorine-containing fluid to the glass sheet surface is preferably in an atmosphere within a pressure range of from (atmospheric pressure−100 Pa) to (atmospheric pressure+100 Pa), and more preferably, in an atmosphere within a pressure range of from (atmospheric pressure−50 Pa) to (atmospheric pressure+50 Pa).

With regard to the gas flow rate, the case where HF is used as the fluorine-containing fluid will be described as a representative example. In the case where a glass sheet is treated with HF, the higher the HF flow rate is, the greater the warpage improvement effect during chemical strengthening treatment is, so that the case is preferable. In the case where the total gas flow rate is equal, the higher the HF concentration is, the greater the warpage improvement effect during chemical strengthening treatment is.

In the case where the total gas flow rate and the HF gas flow rate are constant, the longer the time for treating a glass sheet is, the greater the warpage improvement effect during chemical strengthening treatment is. For example, in the case where a glass sheet is heated and the glass sheet surface is then treated by using HF gas, the warpage after chemical strengthening is improved as the conveying speed of the glass sheet decreases. Even with an equipment where the total gas flow rate or the HF flow rate cannot be well controlled, the warpage after chemical strengthening can be improved by appropriately controlling the conveying speed of a glass sheet.

In forming in a float bath, usually, temperature is higher at an upper stream side in the flow direction of a glass ribbon. The diffusion of fluorine in a glass is more vigorous as the temperature is high, that is, as the viscosity is low. Therefore, in order to increase the penetration depth of fluorine, it is effective to perform the fluorine treatment in a float bath at an upper stream. Alternatively, a similar effect can be obtained by elevating the temperature of the glass ribbon in the treating position.

However, in the case of performing the treatment at an upper stream side, there is a case of passing a process where a glass ribbon becomes thin in the float bath after the treatment. In that case, since the penetration depth of fluorine also decreases as the glass ribbon is thinned, there is a case where the penetration depth of fluorine in the finally obtained glass sheet is smaller than the penetration depth of fluorine in the glass sheet subjected to the same treatment at a lower stream side. Accordingly, in the case where the fluorine treatment is performed in a float bath, it is not always effective to provide the treating position at an exceedingly upper stream side, for the purpose of increasing the penetration depth of fluorine.

For suppressing the generation of a concave portion in a glass sheet and obtaining an improvement effect of warpage after chemical strengthening, the surface temperature of the glass sheet at the time of performing the fluorine treatment is preferably (Tg+90°) C. or higher. Regardless of the above, the surface temperature of the glass sheet is preferably higher than 650° C. in the case where the fluorine treatment is performed at a surface temperature of the glass sheet of 650° C. or lower, a concave portion is likely to be generated. In the present specification, the concave portion is a minute hole generated on the surface of a glass sheet, which hole can be recognized by SEM (Scanning Electron Microscope). If the concave portion is generated on a glass sheet, strength of the glass sheet decreases.

Typically, the concave portion has a shape that decreases its diameter from the surface along the depth direction and extends into a nearly spherical bag shape. The diameter of the concave portion indicates a diameter of the neck between the diameter-reduced part and the bag-shaped part and can be observed by SEM or the like. The depth of the concave portion indicates a depth from the glass surface to the deepest part of the bag-shaped part and can be measured by cross-section SEM observation or the like.

The concave portion in the present invention is one having a size or diameter of 10 nm or more and usually of 20 nm or more, and typically a diameter of 40 nm or less. The depth of the concave portion is usually 10 nm or more and typically 150 nm or less.

In the case where the concave portions are present in a density of more than 7 spots/μm² on the surface having larger fluorine concentration, there is a concern that the strength of the chemically strengthened glass sheet decreases. Therefore, even in the case where there are concave portions, the density thereof is preferably 6 spots/μm² or less, more preferably 4 spots/μm² or less, and most preferably 0 spots/μm². Incidentally, the average distance between concave portions in the case where the concave portion density is 6 spots/μm² is 460 nm.

FIG. 13 illustrates an explanatory view of the mechanism of concave portion generation by HF treatment. It is considered that, by subjecting glass to HF treatment, generation and vaporization of fluorides occur ((a) of FIG. 13) and, in the case where the generation rate of the fluorides due to the reaction of HF with the glass is higher than the vaporization rate of the formed fluorides, the formed fluorides remain on the treated surface ((b) of FIG. 13), molten fluorides undergo crystal growth while etching and also the molten salts decrease ((c) of FIG. 13), and as a result, a final product is observed as the concave portion ((d) of FIG. 13).

### 3. Chemical Strengthening

Chemical strengthening is treatment in which alkali metal ions (typically, Li ions or Na ions) having a smaller ion radius in a glass surface are exchanged with alkali metal ions (typically, K ions) having a larger ion radius by ion exchange at a temperature equal to or lower than a glass transition point to thereby form a compressive stress layer in the glass surface. The chemical strengthening treatment may be performed by a conventionally known method.

In the present invention, a glass sheet having improved warpage after chemical strengthening can be obtained by chemically strengthening a fluorine-introduced glass sheet. The change amount of warpage (warpage change amount) of a glass sheet after chemical strengthening with respect to the glass sheet before the chemical strengthening can be measured by a three-dimensional shape measurement instrument (e.g., manufactured by Mitaka Kohki Co., Ltd.) or a surface roughness/outline shape measurement instrument (e.g., manufactured by Tokyo Seimitsu Co., Ltd.).

In the present invention, the improvement of warpage after chemical strengthening is evaluated by a warpage displacement amount determined by the following formula in an experiment under the same conditions only except that surface treatment is performed by the fluorine-containing fluid.

Warpage Displacement Amount=ΔX−ΔY

ΔX: warpage change amount of untreated glass sheet caused by chemical strengthening

ΔY: warpage change amount of treated glass sheet caused by chemical strengthening

Here, the warpage change amount is a value obtained by subtracting the warpage amount of a glass sheet before chemical strengthening from the warpage amount of the glass sheet after the chemical strengthening. The warpage change amount is as follows: ΔX>0. As for ΔY, ΔY>0 in the case where the warpage occurs in the same direction as that in the case of ΔX and ΔY<0 in the case where the warpage occurs in the direction reverse to that in the case of ΔX.

The warpage change amount of an untreated glass sheet caused by chemical strengthening depends on various conditions and widely varies. The fact that the warpage displace amount is larger than a predetermined value means that the warpage can be controlled regardless of the above variation. Therefore, a glass sheet exhibiting a warpage displacement amount of a predetermined value, specifically 10 μm or more, can reduce the problem of warpage.

CS (surface compressive stress) and DOL (depth of compressive stress layer) of a glass sheet can be measured by a surface stress meter. The surface compressive stress of a chemically strengthened glass is preferably 600 MPa or more, and the depth of the compressive stress layer is preferably 15 μm or more. By controlling the surface compressive stress and the depth of the compressive stress layer of a chemically strengthened glass within the ranges, excellent strength and scratch resistance are obtained.

### 4. Flat Panel Display Device

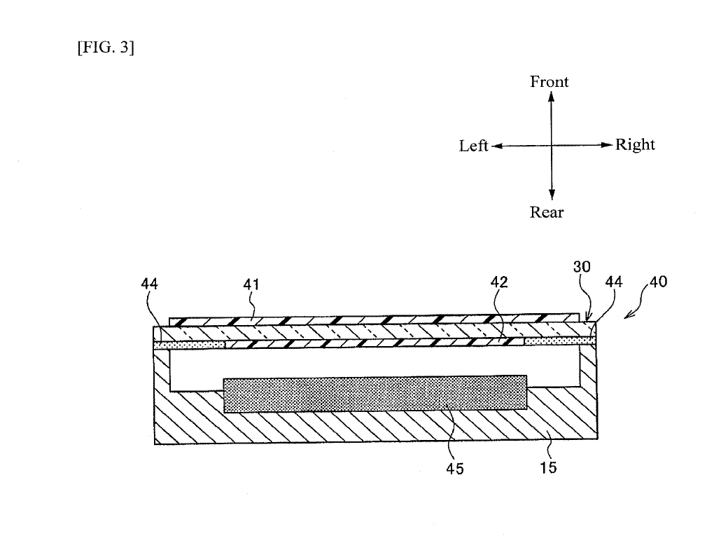

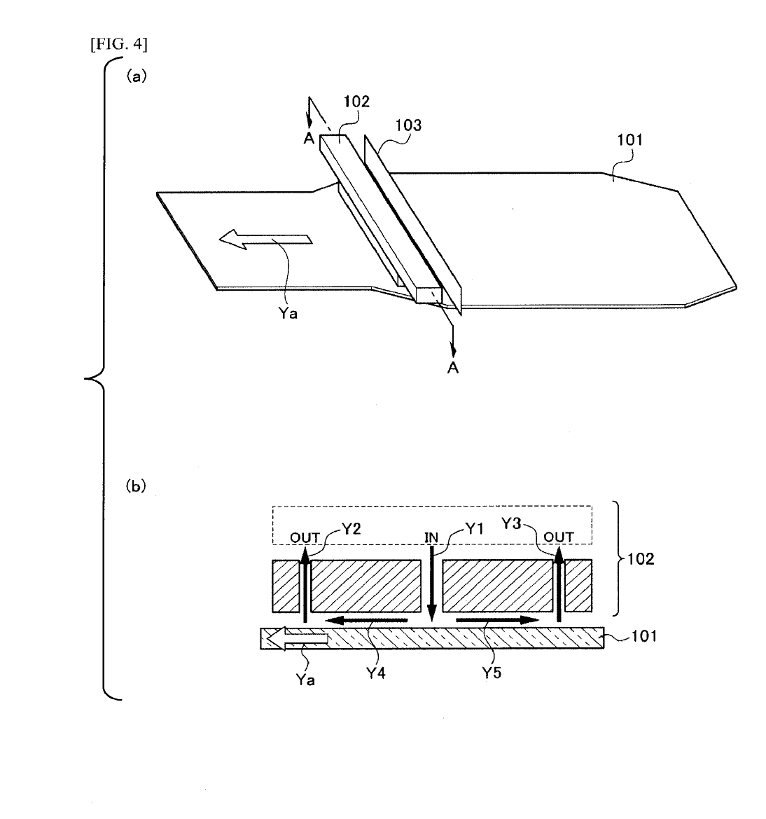

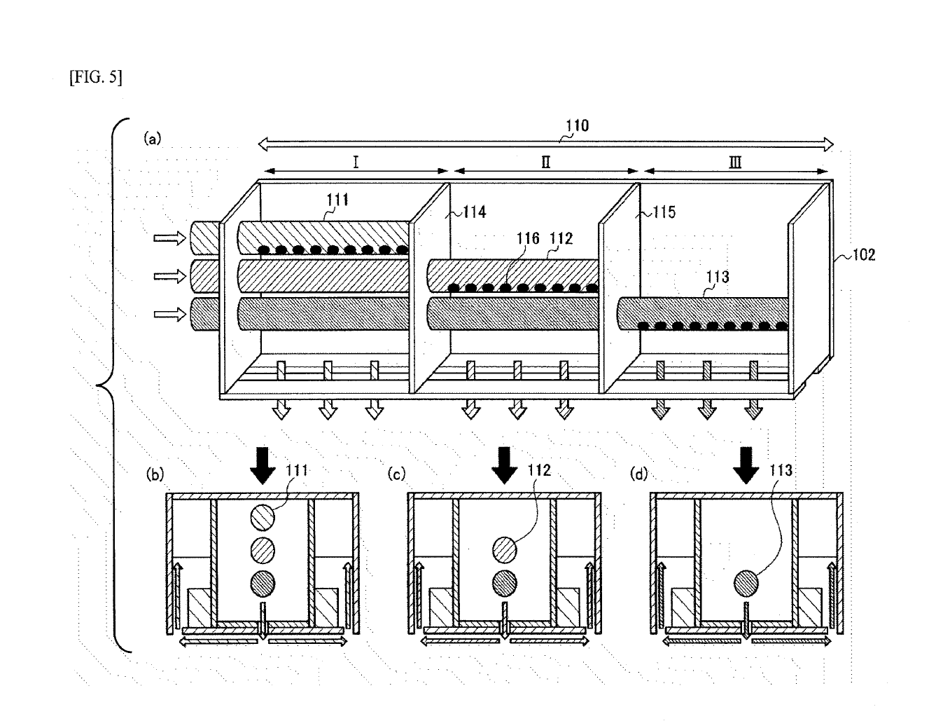

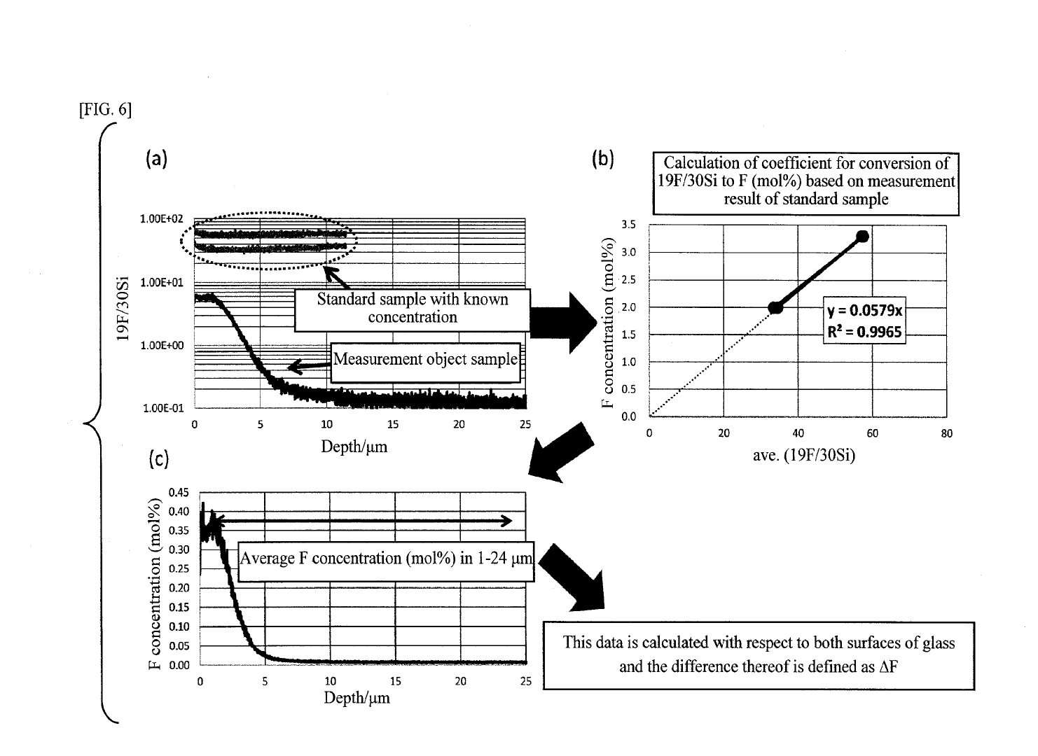

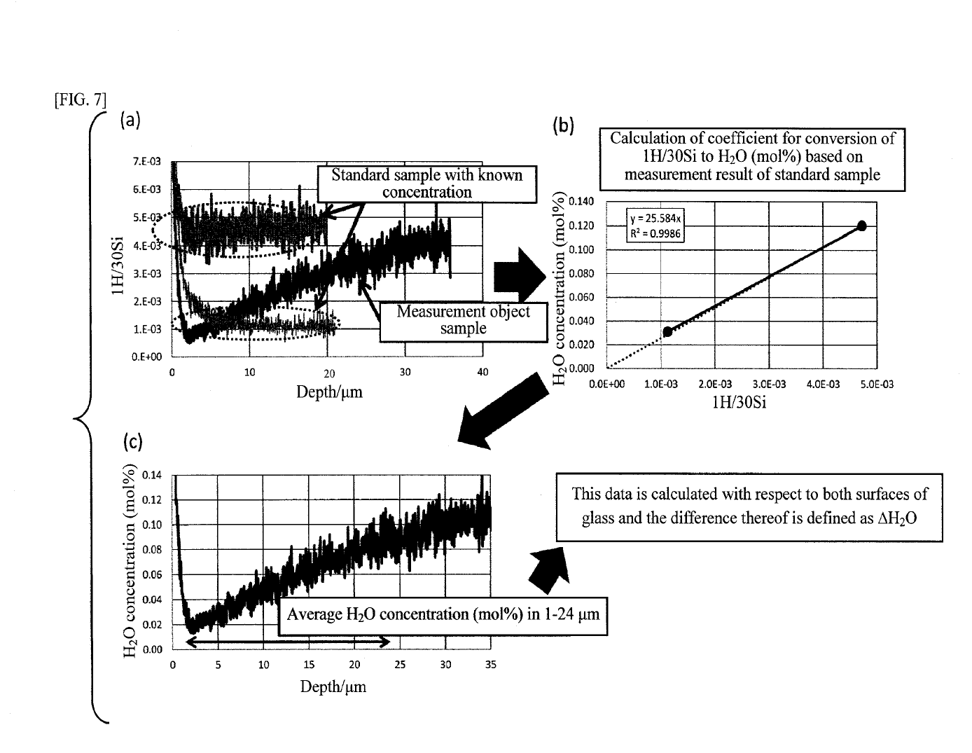

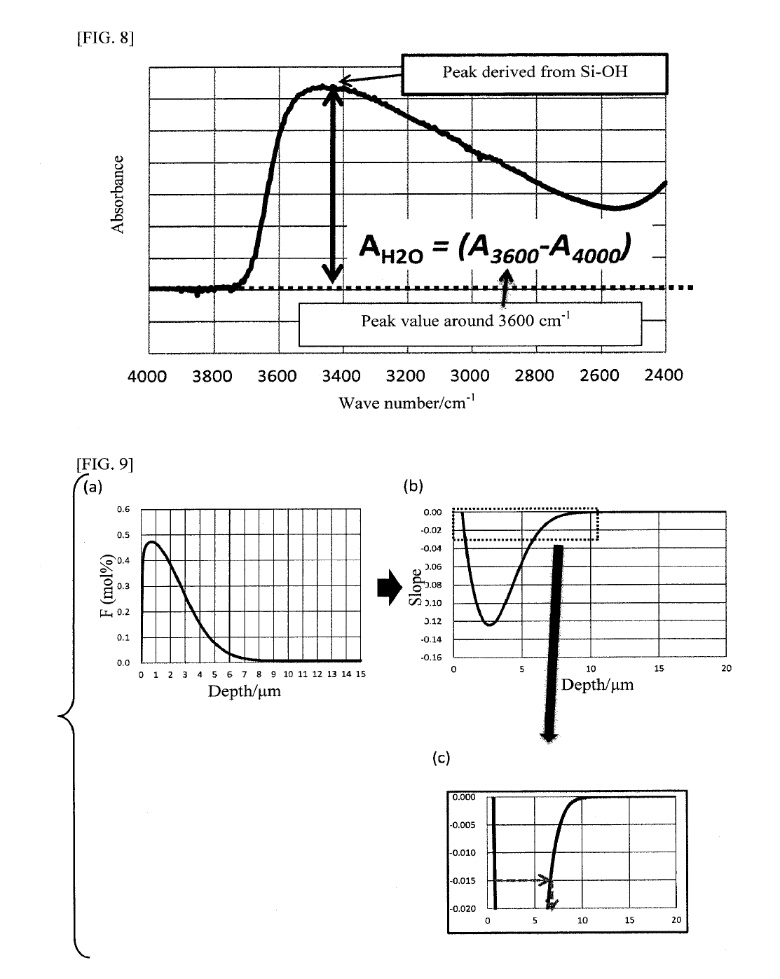

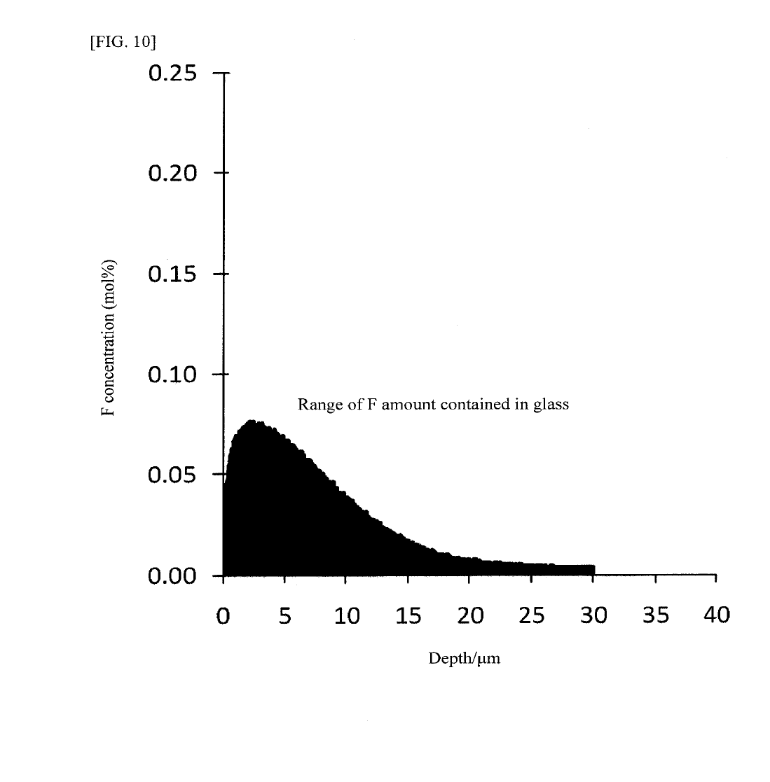

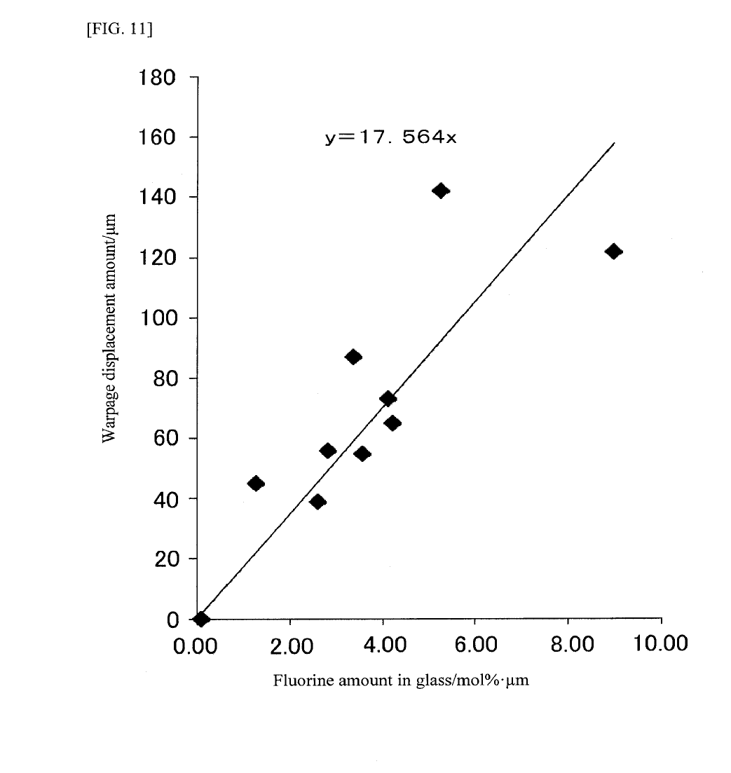

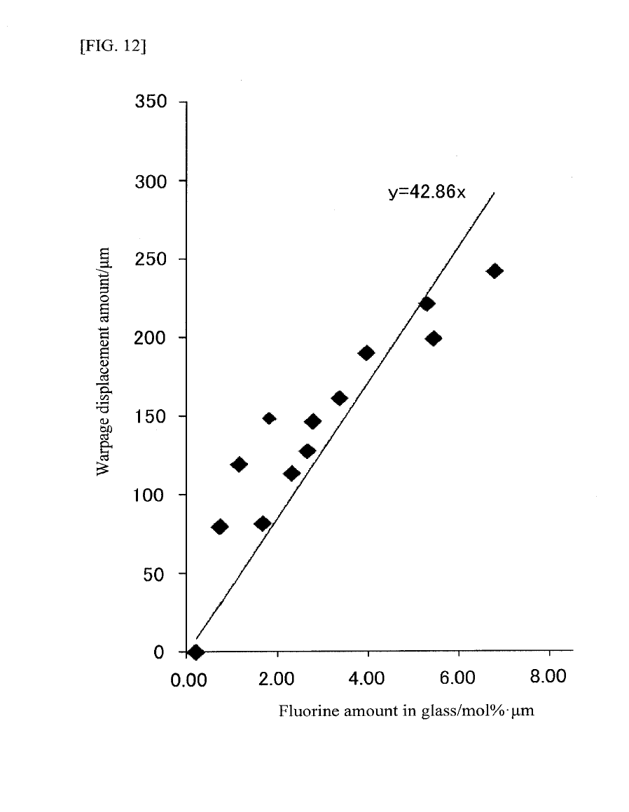

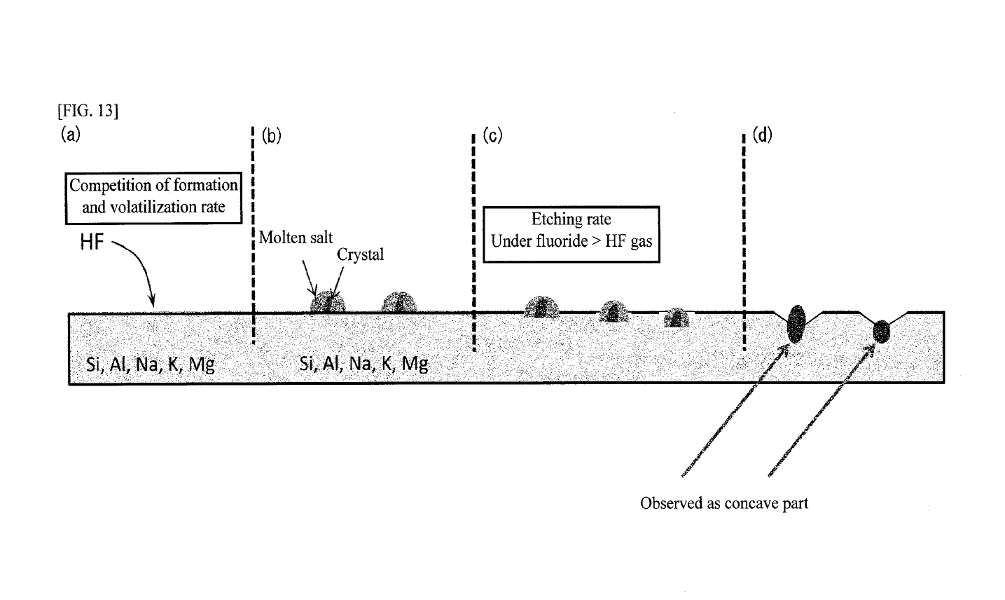

Hereinafter described is an example where the glass sheet of the present invention is chemically strengthened and the chemically strengthened glass is then used as a cover glass for a flat panel display device. FIG. 3 is a cross-sectional view of a display device in which a cover glass is arranged. In the following description, the front, rear, left, and right are based on the directions of arrows in the figure.

As illustrated in FIG. 3, a display device 40 includes a display panel 45 which is provided in a housing 15, and a cover glass 30 which is provided so as to cover the entire surface of the display panel 45 and to surround the front of the housing 15.

The cover glass 30 is primarily provided for the purpose of improving beauty and strength of the display device 40 or preventing damage caused by impact, and is Banned of one sheet of sheet-shaped glass having an entire shape of a substantially planar shape. The cover glass 30 may be arranged so as to be separated from the display side (front side) of the display panel 45 (to have an air layer) as illustrated in FIG. 3, or may be attached to the display side of the display panel 45 through a light-transmissive adhesive film (not illustrated).

A functional film 41 is provided on the front surface of the cover glass 30 on which light from the display panel 45 is emitted, and a functional film 42 is provided on the rear surface, on which light from the display panel 45 is incident, at a position corresponding to the display panel 45. Although the functional films 41 and 42 are provided on both surfaces in FIG. 3, the present invention is not limited thereto, and they may be provided on the front surface or the rear surface or may be omitted.

The functional films 41 and 42 have functions of, for example, preventing reflection of ambient light, preventing damage caused by impact, shielding electromagnetic waves, shielding near infrared rays, correcting color tone, and/or improving scratch resistance, and the thickness, shape and the like thereof are appropriately selected depending on use applications. For example, the functional films 41 and 42 are formed by attaching a resin-made film to the cover glass 30. Alternatively, they may be formed by a thin film-forming method such as a vapor deposition method, a sputtering method, or a CVD method.

Reference numeral 44 indicates a black layer, and for example, is a coating film formed by applying ink containing pigment particles onto the cover glass 30 and performing ultraviolet irradiation or heating and burning, followed by cooling. Thus, the display panel or the like is not viewed from the outside of the housing 15, and the aesthetics of the appearance is improved.

In the case where the glass sheet of the present invention is used as a cover glass of a display device as above, surface roughness (arithmetic average roughness) Ra is preferably 2.5 nm or less and further preferably 1.5 nm or less. As a result, it can be prevented the cover glass from impairing clearness of displayed images on the display device. The surface roughness Ra of a glass sheet can be measured as follows in accordance with JIS B0601 (2001). By using AFM (Atomic Force Microscope), for example, XE-HDM manufactured by Park System as a measuring apparatus, the roughness is measured at three points in a scan size of 1 μm×1 μm and an average value of the values at three points is taken as the Ra value of the glass sheet.

### EXAMPLES

Hereinafter, Examples of the present invention will be specifically described. However, the present invention is not limited thereto.

### (Composition of Glass Sheet)

In the present Examples, glass sheets of glass materials A to D having the following compositions were used.

(Glass material A) Glass containing, in terms of mol %, 72.0% of SiO₂, 1.1% of Al₂O₃, 12.6% of Na₂O, 0.2% of K₂O, 5.5% of MgO, and 8.6% of CaO (glass transition temperature: 566° C.).
(Glass material B) Glass containing, in terms of mol %, 64.3% of SiO₂, 8.0% of Al₂O₃, 12.5% of Na₂O, 4.0% of K₂O, 10.5% of MgO, 0.1% of CaO, 0.1% of SrO, 0.1% of BaO, and 0.5% of ZrO₂ (glass transition temperature: 604° C.).
(Glass material C) Glass containing, in terms of mol %, 68.0% of SiO₂, 10.0% of Al₂O₃, 14.0% of Na₂O, and 8.0% of MgO (glass transition temperature: 662° C.).
(Glass material D) Glass containing, in terms of mol %, 68.8% of SiO₂, 3.0% of Al₂O₃, 14.2% of Na₂O, 7.8% of CaO, 6.2% of MgO, and 0.2% of K₂O (glass transition temperature: 552° C.).

### (Measurement of Warpage Amount)

The warpage amount was measured by SURFCOM surface roughness/outline shape measurement instrument (for example, manufactured by Tokyo Seimitsu Co., Ltd.) before chemical strengthening, and then, each glass was subjected to chemical strengthening, and the warpage amount after chemical strengthening was measured in the same manner, and warpage displacement amount was calculated based on the aforementioned procedures.

### (Secondary Ion Mass Spectrometry; SIMS)

Analytical conditions of the secondary ion mass spectrometry were as follows.

Measurement apparatus: ADEPT 1010 manufactured by ULVAC-PHI Inc.

Primary ion species: Cs⁺

Primary acceleration voltage: 5.0 kV

Primary ion current: 1 μA

Primary ion incident angle (angle from vertical direction of sample surface): 60°

Raster size: 200×200 μm²

Detection area: 40×40 μm²

Secondary ion polarity: minus

Use of electron gun for neutralization: yes

From the obtained results, an intensity ratio (F/Si) was determined according to the aforementioned Formulae w to z and was further converted into fluorine concentration (mol %). There was prepared a depth-direction profile in which a horizontal axis expresses depth and a vertical axis expresses fluorine concentration (mol %), and an integrated value thereof was taken as an amount of fluorine (mol %·μm) contained in the glass.

The depth on the horizontal axis of the depth-direction profile obtained by SIMS analysis was determined by measuring the depth of analysis crater with a stylus type thickness meter (Dektak 150 manufactured by Veeco Corp.).

### (ΔF/ΔH₂O)

By using the aforementioned secondary ion mass spectrometry, thickness-direction distributions of fluorine concentration and H₂O concentration were measured with respect to glass sheets of Examples and Comparative Examples before chemical strengthening as objects. Based on the measurement results, ΔF/ΔH₂O was obtained.

### (Penetration Depth x of Fluorine)

Based on the F concentration profile by SIMS, penetration depth x of fluorine was obtained.

### (Surface Layer Fluorine Ratio)

By using the aforementioned secondary ion mass spectrometry, fluorine concentration was measured with respect to glass sheets of Examples and Comparative Examples before chemical strengthening as objects. Based on the measurement results, the surface layer fluorine ratio was obtained.

### (Presence or Absence of Concave Portion)

The HF-treated surface of glass was subjected to SEM observation and, within observation visual field (magnification: 50,000 to 200,000), a case where one or more concave portions were observed was regarded as “presence of concave portion”.

### (CS and DOL)

CS and DOL were measured by using a surface stress meter (FSM-6000LE) manufactured by Orihara Industrial Co., Ltd.

### (HF Total Contact Amount)

The HF total contact amount (mol/cm²) was determined according to the following formula. The treating time in formula is a time for which HF gas is in contact with the surface of a glass ribbon.

[HF Total contact amount (mol/cm²)]=[HF gas concentration (volume %)]/100×[gas flow rate (mol/s/cm²)]×[Treating time (s)] (b)

### Example 1

In a float bath in which a glass ribbon made of the glass material B flowed, fluorine treatment (hereinafter referred to as HF treatment) was conducted at the treating temperature shown in Table 1 by using HF gas as a fluorine-containing fluid. For the obtained glass, the fluorine penetration depth x and the amount of fluorine contained in the glass were determined.

The obtained glass having a sheet thickness of 0.7 mm was cut into three sheets each 100 mm square, warpage of two diagonal lines of a portion corresponding to a portion 90 mm square of the substrate was measured, and an average value thereof was taken as a warpage amount before strengthening. Thereafter, the glass was immersed in KNO₃ molten salt heated to 450° C. for 2 hours and thus chemical strengthening was performed. Next, warpage of two diagonal lines of a portion corresponding to a portion 90 mm square of the substrate was measured, an average value thereof was taken as a warpage amount after strengthening, and a warpage displacement amount was calculated.

Incidentally, Comparative Example 1-1 is a reference where the HF treatment is not performed.

Tables 1 and 2 show the results.

TABLE 1

| | HF treatment | | | | | | | |
|---|---|---|---|---|---|---|---|---|
| | | HF total | | | Warpage [μm] | | | |
| | Treating | contact | Surface stress | | Before | After | | Warpage |
| | temp. | amount | CS | DOL | chemical | chemical | ΔWarpage | displacement |
| | [° C.] | [mol/cm²] | (MPa) | (μm) | strengthening | strengthening | amount | amount |
| Comp. Ex. 1-1 | 911 | 0.00E+00 | 753.9 | 42.7 | 6.1 | 114.6 | 108.4 | 0.0 |
| Ex. 1-1 | 911 | 1.28E−04 | 745.3 | 42.9 | −9.7 | −29.1 | −19.4 | 127.8 |
| Ex. 1-2 | 911 | 1.70E−04 | 761.3 | 42.6 | −8.2 | −46.4 | −38.1 | 146.5 |
| Ex. 1-3 | 911 | 2.13E−04 | 760.0 | 42.7 | −10.2 | −63.5 | −53.3 | 161.7 |
| Ex. 1-4 | 911 | 3.83E−04 | 748.2 | 43.0 | −16.4 | −150.3 | −133.9 | 242.3 |
| Ex. 1-5 | 911 | 3.40E−04 | 757.1 | 42.7 | −18.2 | −131.3 | −113.1 | 221.5 |
| Ex. 1-6 | 911 | 2.98E−04 | 752.4 | 43.0 | −12.1 | −103.0 | −91.0 | 199.4 |
| Ex. 1-7 | 911 | 2.55E−04 | 726.5 | 43.3 | −14.2 | −96.0 | −81.8 | 190.3 |
| Ex. 1-8 | 911 | 8.51E−05 | 731.3 | 43.3 | −9.5 | −14.6 | −5.0 | 113.4 |
| Ex. 1-9 | 911 | 4.25E−05 | 737.1 | 42.9 | −7.8 | 18.7 | 26.5 | 81.9 |
| Ex. 1-10 | 911 | 7.66E−05 | 739.3 | 43.0 | −7.7 | −15.8 | −8.2 | 116.6 |
| Ex. 1-11 | 911 | 1.02E−04 | 765.4 | 42.5 | −10.1 | −15.9 | −5.8 | 114.2 |
| Ex. 1-12 | 911 | 1.28E−04 | 743.5 | 43.1 | −7.2 | −27.2 | −19.9 | 128.3 |
| Ex. 1-13 | 911 | 1.53E−04 | 736.3 | 43.3 | −11.0 | −25.4 | −14.4 | 122.8 |
| Ex. 1-14 | 911 | 7.66E−05 | 736.8 | 43.2 | −8.3 | −28.0 | −19.6 | 128.0 |
| Ex. 1-15 | 911 | 1.02E−04 | 742.2 | 43.3 | −11.5 | −29.6 | −18.2 | 126.6 |
| Ex. 1-16 | 911 | 1.53E−04 | 743.2 | 43.0 | −7.4 | −19.2 | −11.8 | 120.2 |

TABLE 2

| | F concentration analysis | | | H₂O concentration analysis | | | | |
|---|---|---|---|---|---|---|---|---|
| | T surface | B surface | | T surface | B surface | | | Amount of |
| | Ave. F | Ave. F | T surface- | Ave. | Ave. | B surface- | | fluorine |
| | conc. of | conc. of | B surface | H₂O conc. | H₂O conc. | T surface | | contained |
| | 1-24 μm | 1-24 μm | ΔF | of 1-24 μm | of 1-24 μm | ΔH₂O | x | in glass |
| | [mol %] | [mol %] | [mol %] | [mol %] | [mol %] | [mol %] | (μm) | [/mol % · μm] |
| Comp. Ex. 1-1 | 0.008 | 0.008 | 0.000 | 0.077 | 0.099 | 0.023 | 0.0 | 0.23 |
| Ex. 1-1 | 0.106 | 0.008 | 0.098 | 0.077 | 0.099 | 0.023 | 16.0 | 2.65 |
| Ex. 1-2 | 0.111 | 0.008 | 0.103 | 0.077 | 0.099 | 0.023 | 13.0 | 2.78 |
| Ex. 1-3 | 0.135 | 0.008 | 0.127 | 0.077 | 0.099 | 0.023 | 17.0 | 3.36 |
| Ex. 1-4 | 0.275 | 0.008 | 0.268 | 0.077 | 0.099 | 0.023 | 19.0 | 6.80 |
| Ex. 1-5 | 0.213 | 0.008 | 0.205 | 0.077 | 0.099 | 0.023 | 18.0 | 5.29 |
| Ex. 1-6 | 0.220 | 0.008 | 0.212 | 0.077 | 0.099 | 0.023 | 19.0 | 5.45 |
| Ex. 1-7 | 0.160 | 0.008 | 0.152 | 0.077 | 0.099 | 0.023 | 15.0 | 3.97 |
| Ex. 1-8 | 0.092 | 0.008 | 0.084 | 0.077 | 0.099 | 0.023 | 13.0 | 2.31 |
| Ex. 1-9 | 0.066 | 0.008 | 0.058 | 0.077 | 0.099 | 0.023 | 11.0 | 1.66 |
| Ex. 1-10 | 0.087 | 0.008 | 0.080 | 0.077 | 0.099 | 0.023 | 16.1 | 2.20 |
| Ex. 1-11 | 0.086 | 0.008 | 0.078 | 0.077 | 0.099 | 0.023 | 13.7 | 2.17 |
| Ex. 1-12 | 0.089 | 0.008 | 0.081 | 0.077 | 0.099 | 0.023 | 14.7 | 2.24 |
| Ex. 1-13 | 0.091 | 0.008 | 0.084 | 0.077 | 0.099 | 0.023 | 15.8 | 2.30 |
| Ex. 1-14 | 0.089 | 0.008 | 0.082 | 0.077 | 0.099 | 0.023 | 17.0 | 2.26 |
| Ex. 1-15 | 0.086 | 0.008 | 0.078 | 0.077 | 0.099 | 0.023 | 14.5 | 2.16 |
| Ex. 1-16 | 0.095 | 0.008 | 0.087 | 0.077 | 0.099 | 0.023 | 17.5 | 2.39 |

As shown in Tables 1 and 2, it was found that the warpage after chemical strengthening was effectively improved in Examples 1-1 to 1-16 where x (μm) was 10 or more and the amount of fluorine contained in the glass was more than 0.23 mol %·μm.

### Example 2

In a float bath in which a glass ribbon made of the glass material A or B flowed, HF treatment was conducted at the treating temperature shown in Table 3, and the amount of fluorine contained in the glass and the fluorine penetration depth x were determined.

The obtained glass having a sheet thickness of 0.7 mm was cut into three sheets each 100 mm square, warpage of two diagonal lines of a portion corresponding to a portion 90 mm square of the substrate was measured, and an average value thereof was taken as a warpage amount before strengthening. Thereafter, the glass sheet made of the glass material B was immersed in KNO₃ molten salt heated to 450° C. for 2 hours or the glass sheet made of the glass material A was immersed in KNO₃ molten salt heated to 420° C. for 2.5 hours, and thus chemical strengthening was performed. Next, warpage of two diagonal lines of a portion corresponding to a portion 90 mm square of the substrate was measured, an average value thereof was taken as a warpage amount after strengthening, and a warpage displacement amount was calculated.

Comparative Examples 2-1 and 2-2 are references where the HF treatment is not performed.

Tables 3 and 4 show the results.

TABLE 3

| | HF treatment | | | | | | | |
|---|---|---|---|---|---|---|---|---|
| | | HF total | | | Warpage [μm] | | | |
| | | contact | Surface stress | | Before | After | | Warpage |
| | Treating | amount | CS | DOL | chemical | chemical | ΔWarpage | displacement |
| | temp. [° C.] | [mol/cm²] | (MPa) | (μm) | strengthemng | strengthening | amount | amount |
| Ex. 2-1 | 757 | 1.28E−05 | 768.5 | 46.9 | 10.4 | 122.9 | 112.5 | 47.5 |
| Ex. 2-2 | 757 | 6.39E−05 | 757.5 | 49.2 | 10.8 | 67.4 | 56.6 | 103.4 |
| Ex. 2-3 | 757 | 4.82E−05 | 791.4 | 46.2 | 12.8 | 75.3 | 62.5 | 97.5 |
| Ex. 2-4 | 757 | 9.58E−05 | 789.3 | 48.4 | 8.0 | 22.4 | 14.4 | 145.6 |
| Ex. 2-5 | 757 | 1.44E−04 | 779.9 | 48.2 | 10.6 | −12.1 | −22.7 | 182.7 |
| Ex. 2-6 | 757 | 1.28E−04 | 764.7 | 47.6 | 5.0 | 39.1 | 34.1 | 125.9 |
| Ex. 2-7 | 757 | 2.55E−04 | 755.3 | 47.7 | 3.3 | −85.5 | −88.8 | 248.8 |
| Ex. 2-8 | 690 | 9.58E−05 | 770.4 | 47.7 | 6.6 | 74.8 | 68.2 | 91.8 |
| Ex. 2-9 | 627 | 1.05E−04 | 786.9 | 47.8 | 8.5 | 125.5 | 117.0 | 43.0 |
| Comp. Ex. 2-1 | — | 0.00E+00 | 775.3 | 47.3 | 13.2 | 173.2 | 160.0 | 0.0 |
| Comp. Ex. 2-2 | 733 | 0.00E+00 | 723.8 | 6.8 | 6.1 | 61.7 | 55.6 | 0.0 |
| Ex. 2-10 | 788 | 6.17E−04 | 636.5 | 6.4 | −4.6 | 1.3 | 5.9 | 49.7 |
| Ex. 2-11 | 788 | 4.63E−04 | 633.4 | 6.4 | −7.1 | −7.7 | −0.6 | 56.2 |
| Ex. 2-12 | 788 | 3.09E−04 | 646.1 | 6.4 | 4.3 | 17.6 | 13.3 | 42.3 |
| Ex. 2-13 | 788 | 9.26E−04 | 604.8 | 6.5 | −16.1 | −57.4 | −41.3 | 96.9 |
| Ex. 2-14 | 733 | 3.09E−04 | 660.0 | 6.6 | −6.8 | 11.3 | 18.1 | 37.5 |
| Ex. 2-15 | 733 | 6.17E−04 | 601.7 | 6.6 | −6.5 | −22.8 | −16.3 | 71.9 |
| Ex. 2-16 | 733 | 1.23E−03 | 515.8 | 6.7 | −14.8 | −78.1 | −63.3 | 118.9 |
| Ex. 2-17 | 733 | 1.54E−04 | 662.9 | 6.5 | −0.9 | 15.2 | 16.1 | 39.5 |
| Ex. 2-18 | 647 | 3.09E−04 | 660.9 | 7.0 | 4.4 | 35.8 | 31.3 | 24.3 |
| Ex. 2-19 | 647 | 6.17E−04 | 637.6 | 6.4 | −5.0 | 23.9 | 28.9 | 26.7 |
| Ex. 2-20 | 647 | 3.09E−04 | 674.4 | 7.0 | −5.4 | 17.7 | 23.1 | 32.5 |
| Ex. 2-21 | 647 | 6.17E−04 | 655.5 | 6.3 | −5.5 | 4.1 | 9.6 | 46.0 |

TABLE 4

| | F concentration analysis | | | H₂O concentration analysis | | | | |
|---|---|---|---|---|---|---|---|---|
| | T surface | B surface | | T surface | B surface | | | Amount of |
| | Ave. F | Ave. F | T surface- | Ave. | Ave. | B surface- | | fluorine |
| | conc. of | conc. of | B surface | H₂O conc. | H₂O conc. | T surface | | contained |
| | 1-24 μm | 1-24 μm | ΔF | of 1-24 μm | of 1-24 μm | ΔH₂O | x | in glass |
| | [mol %] | [mol %] | [mol %] | [mol %] | [mol %] | [mol %] | (μm) | [/mol % · μm] |
| Ex. 2-1 | 0.019 | 0.008 | 0.011 | 0.075 | 0.099 | 0.024 | 3.5 | 0.60 |
| Ex. 2-2 | 0.042 | 0.008 | 0.034 | 0.077 | 0.099 | 0.023 | 5.2 | 1.35 |
| Ex. 2-3 | 0.022 | 0.008 | 0.014 | 0.074 | 0.099 | 0.026 | 4.5 | 0.72 |
| Ex. 2-4 | 0.035 | 0.008 | 0.027 | 0.075 | 0.099 | 0.024 | 4.9 | 1.13 |
| Ex. 2-5 | 0.053 | 0.008 | 0.045 | 0.076 | 0.099 | 0.024 | 5.5 | 1.80 |
| Ex. 2-6 | 0.039 | 0.008 | 0.031 | 0.074 | 0.099 | 0.025 | 4.9 | 1.26 |
| Ex. 2-7 | 0.075 | 0.008 | 0.067 | 0.074 | 0.099 | 0.025 | 6.1 | 2.66 |
| Ex. 2-8 | 0.022 | — | — | — | — | — | — | 0.89 |
| Ex. 2-9 | 0.030 | — | — | — | — | — | — | 1.04 |
| Comp. Ex. 2-1 | 0.007 | 0.008 | 0.001 | 0.077 | 0.099 | 0.023 | 0.0 | 0.21 |
| Comp. Ex. 2-2 | 0.0027 | 0.0048 | 0.002 | 0.0403 | 0.0724 | 0.0321 | 0.0 | 0.10 |
| Ex. 2-10 | 0.1361 | 0.0048 | 0.1313 | 0.0403 | 0.0724 | 0.0321 | 8.9 | 4.12 |
| Ex. 2-11 | 0.1360 | 0.0048 | 0.1312 | 0.0403 | 0.0724 | 0.0321 | 8.2 | 4.22 |
| Ex. 2-12 | 0.0918 | 0.0048 | 0.0870 | 0.0403 | 0.0724 | 0.0321 | 7.8 | 2.82 |
| Ex. 2-13 | 0.3162 | 0.0048 | 0.3113 | 0.0403 | 0.0724 | 0.0321 | 12.0 | 8.98 |
| Ex. 2-14 | 0.0244 | 0.0048 | 0.0196 | 0.0403 | 0.0724 | 0.0321 | 3.6 | 1.26 |
| Ex. 2-15 | 0.0689 | 0.0048 | 0.0641 | 0.0403 | 0.0724 | 0.0321 | 5.0 | 3.37 |
| Ex. 2-16 | 0.1155 | 0.0048 | 0.1106 | 0.0403 | 0.0724 | 0.0321 | 5.3 | 5.26 |
| Ex. 2-17 | 0.0235 | 0.0048 | 0.0186 | 0.0403 | 0.0724 | 0.0321 | 3.7 | 1.17 |
| Ex. 2-18 | 0.0247 | 0.0048 | 0.0198 | 0.0403 | 0.0724 | 0.0321 | 3.1 | 2.56 |
| Ex. 2-19 | 0.0452 | 0.0048 | 0.0404 | 0.0403 | 0.0724 | 0.0321 | 4.2 | 3.87 |
| Ex. 2-20 | 0.0240 | 0.0048 | 0.0192 | 0.0403 | 0.0724 | 0.0321 | 2.9 | 2.60 |
| Ex. 2-21 | 0.0405 | 0.0048 | 0.0356 | 0.0403 | 0.0724 | 0.0321 | 3.4 | 3.57 |

As shown in Tables 3 and 4, it was found that the warpage after chemical strengthening was effectively improved in Examples 2-1 to 2-21 where x (μm) was 1 or more and the amount of fluorine contained in the glass was more than 0.23 mol %·μm.

### Example 3

HF treatment was conducted in the same manner as in Example 1 in a float bath in which a glass ribbon made of the glass material C (Examples 3-1 to 3-6 and Comparative Examples 3-1 and 3-2) flowed, except that the glass material B was changed to the glass material C and the time for the chemical strengthening treatment was changed to 1.5 hours. The resulting glass was subjected to measurements by the same procedures as in Example 1 and the amount of fluorine contained in the glass (F0-30), the fluorine penetration depth x, the surface layer fluorine ratio, ΔF/ΔH₂O, the warpage amount before strengthening, the warpage amount after strengthening, the warpage displacement amount, and the like were calculated.

Comparative Examples 3-1 and 3-2 are references where the HF treatment is not performed.

Tables 5 and 6 show the results.

TABLE 5

| | HF treatment | | | | | | | |
|---|---|---|---|---|---|---|---|---|
| | | HF total | | | Warpage [μm] | | | |
| | Treating | contact | Surface stress | | Before | After | | Warpage |
| | temp. | amount | CS | DOL | chemical | chemical | ΔWarpage | displacement |
| | [° C.] | [mol/cm²] | (MPa) | (μm) | strengthening | strengthening | amount | amount |
| Comp. Ex. 3-1 | 975 | 0.00E+00 | 936.9 | 26.9 | 7.0 | 78.9 | 71.9 | 0.0 |
| Comp. Ex. 3-2 | 963 | 0.00E+00 | 939.7 | 27.1 | 4.2 | 58.6 | 54.4 | 0.0 |
| Ex. 3-1 | 975 | 5.60E−05 | 933.8 | 27 | −1.9 | 15.3 | 17.2 | 54.6 |
| Ex. 3-2 | 975 | 6.22E−05 | 939.6 | 26.9 | −3.3 | 4.1 | 7.4 | 64.5 |
| Ex. 3-3 | 975 | 1.24E−04 | 916.3 | 27.1 | −10.6 | −28.3 | −17.7 | 89.6 |
| Ex. 3-4 | 963 | 6.22E−05 | 950.7 | 27 | −8.3 | −13.9 | −5.6 | 60.0 |
| Ex. 3-5 | 963 | 6.22E−05 | 933.5 | 27.1 | −9.7 | −36.6 | −26.9 | 81.3 |
| Ex. 3-6 | 963 | 1.62E−04 | 943.7 | 27.1 | −11.7 | −47.8 | −36.1 | 90.5 |

TABLE 6

| | | | | H₂O concentration analysis | | | | | | | Surface |
|---|---|---|---|---|---|---|---|---|---|---|---|
| | F concentration analysis | | | T surface | B surface | | | | | | layer |
| | T surface | B surface | T surface- | Ave. H₂O | Ave. H₂O | B surface- | | | | | fluorine |
| | Ave. F conc. | Ave. F conc. | B surface | conc. of | conc. of | T surface | | | | | ratio |
| | of 1-24 μm | of 1-24 μm | ΔF | 1-24 μm | 1-24 μm | ΔH₂O | ΔF/ | x | | | (F0-3/ |
| | [mol %] | [mol %] | [mol %] | [mol %] | [mol %] | [mol %] | ΔH₂O | (μm) | F0-3 | F0-30 | F0-30) |
| Comp. | 0.005 | 0.0052 | 0.000 | 0.0458 | 0.0720 | 0.026 | 0.00 | — | 0.01 | 0.16 | 0.08 |
| Ex. 3-1 | | | | | | | | | | | |
| Comp. | 0.0052 | 0.0052 | 0.000 | 0.0458 | 0.0720 | 0.026 | 0.00 | — | 0.01 | 0.16 | 0.08 |
| Ex. 3-2 | | | | | | | | | | | |
| Ex. 3-1 | 0.054 | 0.0052 | 0.049 | 0.0458 | 0.0720 | 0.026 | 1.88 | 10.6 | 0.29 | 1.38 | 0.21 |
| Ex. 3-2 | 0.064 | 0.0052 | 0.059 | 0.0458 | 0.0720 | 0.026 | 2.26 | 14.5 | 0.34 | 1.63 | 0.21 |
| Ex. 3-3 | 0.091 | 0.0052 | 0.085 | 0.0458 | 0.0720 | 0.026 | 3.27 | 12.6 | 0.49 | 2.29 | 0.22 |
| Ex. 3-4 | 0.044 | 0.0052 | 0.039 | 0.0458 | 0.0720 | 0.026 | 1.48 | 10.9 | 0.24 | 1.13 | 0.21 |
| Ex. 3-5 | 0.068 | 0.0052 | 0.063 | 0.0458 | 0.0720 | 0.026 | 2.39 | 12.6 | 0.39 | 1.72 | 0.23 |
| Ex. 3-6 | 0.076 | 0.0052 | 0.070 | 0.0458 | 0.0720 | 0.026 | 2.69 | 15.9 | 0.45 | 1.92 | 0.23 |

As shown in Tables 5 and 6, it was found that the warpage after chemical strengthening was effectively improved in Examples 3-1 to 3-6 where x (μm) was 10 or more and the amount of fluorine contained in the glass (F0-30) was more than 0.23 mol %·μm.

### Example 4

HF treatment was conducted in the same manner as in Example 1 in a float bath in which a glass ribbon made of the glass material D (Examples 4-1 to 4-4 and Comparative Example 4-1) flowed, except that the glass material B was changed to the glass material D, the temperature of the chemical strengthening treatment was changed to 420° C., and the time for the treatment was changed to 2.5 hours. The resulting glass was subjected to measurements by the same procedures as in Example 1 and the amount of fluorine contained in the glass (F0-30), the fluorine penetration depth x, the surface layer fluorine ratio, ΔF/ΔH₂O, the warpage amount before strengthening, the warpage amount after strengthening, the warpage displacement amount, and the like were calculated.

Comparative Example 4-1 is a reference where the HF treatment is not performed

Tables 7 and 8 show the results.

TABLE 7

| | HF treatment | | | | | | | |
|---|---|---|---|---|---|---|---|---|
| | | HF total | | | Warpage [μm] | | | |
| | Treating | contact | Surface stress | | Before | After | | Warpage |
| | temp. | amount | CS | DOL | chemical | chemical | ΔWarpage | displacement |
| | [° C.] | [mol/cm²] | (MPa) | (μm) | strengthening | strengthening | amount | amount |
| Comp. Ex. 4-1 | 830 | 0.00E+00 | 782.7 | 9.3 | 8.1 | 81.2 | 73.1 | 0.0 |
| Ex. 4-1 | 830 | 6.17E−04 | 757.5 | 8.9 | −4.3 | 20.1 | 24.4 | 48.7 |
| Ex. 4-2 | 830 | 9.26E−04 | 736 | 8.7 | −9.4 | −13.3 | −3.9 | 77.0 |
| Ex. 4-3 | 830 | 1.54E−03 | 698.2 | 7.6 | −21.2 | −61.1 | −39.8 | 112.9 |
| Ex. 4-4 | 830 | 7.71E−04 | 731.2 | 8.7 | −11.3 | −15.0 | −3.8 | 76.8 |

TABLE 8

| | F concentration analysis | | | H₂O concentration analysis | | | | | | | Surface |
|---|---|---|---|---|---|---|---|---|---|---|---|
| | T surface | B surface | | T surface | B surface | | | | | | layer |
| | Ave. F | Ave. F | T surface- | Ave. H₂O | Ave. H₂O | B surface- | | | | | fluorine |
| | conc. of | conc. of | B surface | conc. of | conc. of | T surface | | | | | ratio |
| | 1-24 μm | 1-24 μm | ΔF | 1-24 μm | 1-24 μm | ΔH2O | ΔF/ | x | | | (F0-3/ |
| | [mol %] | [mol %] | [mol %] | [mol %] | [mol %] | [mol %] | ΔH₂O | (μm) | F0-3 | F0-30 | F0-30) |
| Comp. | 0.005 | 0.0046 | 0.000 | 0.0302 | 0.0691 | 0.039 | 0.00 | — | 0.02 | 0.14 | 0.18 |
| Ex. 4-1 | | | | | | | | | | | |
| Ex. 4-1 | 0.130 | 0.0046 | 0.125 | 0.0302 | 0.0691 | 0.039 | 3.23 | 11.2 | 1.59 | 3.48 | 0.46 |
| Ex. 4-2 | 0.232 | 0.0046 | 0.227 | 0.0302 | 0.0691 | 0.039 | 5.84 | 12.6 | 2.87 | 6.21 | 0.46 |
| Ex. 4-3 | 0.427 | 0.0046 | 0.423 | 0.0302 | 0.0691 | 0.039 | 10.87 | 14.8 | 4.47 | 11.26 | 0.40 |
| Ex. 4-4 | 0.279 | 0.0046 | 0.274 | 0.0302 | 0.0691 | 0.039 | 7.06 | 14.2 | 3.30 | 7.48 | 0.44 |

As shown in Tables 7 and 8, it was found that the warpage after chemical strengthening was effectively improved in Examples 4-1 to 4-4 where x (μm) was 10 or more and the amount of fluorine contained in the glass (F0-30) was more than 0.23 mol %·μm.

While the present invention has been described in detail with reference to specific embodiments thereof, it will be apparent to one skilled in the art that various changes and modifications can be made therein without departing from the spirit and scope of the invention.

The present application is based on Japanese Patent Application No. 2013-198468 filed on Sep. 25, 2013, Japanese Patent Application No. 2013-258466 filed on Dec. 13, 2013, and Japanese Patent Application No. 2013-258467 filed on Dec. 13, 2013, and the contents thereof are incorporated herein by reference.

### DESCRIPTION OF REFERENCE NUMERALS AND SIGNS

1: Center slit
2: Outer slit
4: Channel
5: Discharge slit
15: Housing
20: Glass sheet
30: Cover glass
40: Display device
41, 42: Functional film
45: Display panel
101: Glass ribbon
102: Beam
103: Radiation gate
110: Width direction of glass ribbon
111, 112, 113: Gas system
114, 115: Partition wall
116: Gas blowing hole

1. A glass sheet having a fluorine concentration at one surface larger than a fluorine concentration at the other surface, the surfaces being opposite to each other in a thickness direction, wherein the following Formula (1) is satisfied and the amount of fluorine contained in the glass is more than 0.23 mol %·μm and 21 mol %·μm or less on a depth-direction profile by secondary ion mass spectrometry (SIMS) in which a horizontal axis expresses depth and a vertical axis expresses fluorine concentration (mol %), the fluorine concentration being an average fluorine concentration (mol %) by SIMS in the depth of from 1 to 24 μm:
1≦x (1)
in Formula (1), x is a maximum depth (μm) in which a slope at an arbitrary depth xi (μm) in the fluorine concentration profile by SIMS satisfies the following Formula (2):
[F(xi+0.1)−F(xi)]/0.1=−0.015 (2)
in Formula (2), F(xi) represents a fluorine concentration (mol %) by SIMS at the depth xi (μm).

2. The glass sheet according to claim 1, wherein the amount of fluorine contained in the glass is 0.7 mol %·μm or more and 9 mol %·μm or less.

3. A glass sheet having a fluorine concentration at one surface larger than a fluorine concentration at the other surface, the surfaces being opposite to each other in a thickness direction, wherein the following Formula (1′) is satisfied, the fluorine concentration being an average fluorine concentration (mol %) by SIMS in a depth of from 1 to 24 nm:
10≦x (1′)
in Formula (1′), x is a maximum depth (μm) in which a slope at an arbitrary depth xi (μm) in a fluorine concentration profile by SIMS satisfies the following Formula (2):
[F(xi+0.1)−F(xi)]/0.1=−0.015 (2)
in Formula (2), F(xi) represents a fluorine concentration (mol %) by SIMS at the depth xi (μm).

4. The glass sheet according to claim 1, which is a glass sheet manufactured by a float process.

5. The glass sheet according to claim 1, which has a thickness of 1.5 mm or less.

6. The glass sheet according to claim 1, which has a thickness of 0.8 mm or less.

7. The glass sheet according to claim 1, which has a surface roughness Ra of 2.5 nm or less.

8. A glass sheet obtained by chemically strengthening the glass sheet described in claim 1.

9. A flat panel display device equipped with a cover glass, wherein the cover glass is the glass sheet described in claim 8.

10. The glass sheet according to claim 3, which is a glass sheet manufactured by a float process.

11. The glass sheet according to claim 3, which has a thickness of 1.5 mm or less.

12. The glass sheet according to claim 3, which has a thickness of 0.8 mm or less.

13. The glass sheet according to claim 3, which has a surface roughness Ra of 2.5 nm or less.

14. A glass sheet obtained by chemically strengthening the glass sheet according to claim 3.

15. A flat panel display device equipped with a cover glass, wherein the cover glass is the glass sheet according to claim 14.
